(19) United States
(12) Patent Application Publication
(10) Pub. No.: US 2024/0172024 A1
(43) Pub. Date: May 23, 2024

(54) METHOD FOR MEASUREMENT-OCCASION DETERMINATION, TERMINAL DEVICE, AND CHIP

(71) Applicant: GUANGDONG OPPO MOBILE TELECOMMUNICATIONS CORP., LTD., Dongguan (CN)

(72) Inventors: Jinyu ZHANG, Dongguan (CN); Rongyi HU, Dongguan (CN)

(21) Appl. No.: 18/424,824

(22) Filed: Jan. 28, 2024

Related U.S. Application Data
(63) Continuation of application No. PCT/CN2021/110158, filed on Aug. 2, 2021.

(51) Int. Cl. H04W 24/10; H04W 24/08

(52) U.S. Cl. CPC H04W 24/10; H04W 24/08

(57) ABSTRACT

A method for measurement-occasion determination, a terminal device, and a chip are provided in the disclosure. The method includes the following. A terminal device determines a measurement occasion of a first measurement object (MO) in at least one measurement occasion according to whether a measurement gap (MG) and/or a network control small gap (NCSG) are needed for measurement of the first MO. The at least one measurement occasion includes the NCSG.

### CROSS-REFERENCE TO RELATED APPLICATION(S)

This application is a continuation of International Application No. PCT/CN2021/110158, filed Aug. 2, 2021, the entire disclosure of which is incorporated herein by reference.

### TECHNICAL FIELD

This disclosure relates to the field of communications, and in particular, to a method for measurement-occasion determination, a terminal device, and a chip.

### BACKGROUND

In wireless mobile communication systems, radio resource management and mobility management can be effectively performed based on accurate measurement of both cell quality and beam quality.

At present, terminal devices can measure measurement objects (MOs) within measurement gaps (MGs). Measurement within MGs may interrupt data transmission. How to reduce time in which data transmission is interrupted (“data interruption time”) is an urgent problem to-be-solved in a measurement scenario.

### SUMMARY

In view of above, a method for measurement-occasion determination, a terminal device, and a chip are provided in embodiments of the disclosure.

A method for measurement-occasion determination is provided in embodiments of the disclosure. The method includes the following. A terminal device determines a measurement occasion of a first MO in at least one measurement occasion according to whether a measurement gap (MG) and/or a network control small gap (NCSG) are needed for measurement of the first MO. The at least one measurement occasion includes the NCSG.

A terminal device is further provided in embodiments of the disclosure. The terminal device includes a processor and a memory. The memory is configured to store computer programs. The processor is configured to invoke and execute the computer programs stored in the memory to determine a measurement occasion of a first MO in at least one measurement occasion according to whether an MG and/or an NCSG are needed for measurement of the first MO. The at least one measurement occasion includes the NCSG.

A chip is further provided in embodiments of the disclosure. The chip includes a processor. The processor is configured to invoke and execute computer programs stored in a memory to enable a device equipped with the chip to determine a measurement occasion of a first MO in at least one measurement occasion according to whether an MG and/or an NC SG are needed for measurement of the first MO. The at least one measurement occasion includes the NCSG

Other features and aspects of the disclosed features will become apparent from the following detailed description, taken in conjunction with the accompanying drawings, which illustrate, by way of example, the features in accordance with implementations the disclosure. The summary is not intended to limit the scope of any implementations described herein.

### BRIEF DESCRIPTION OF THE DRAWINGS

FIG. 1 is a schematic diagram of a communication system architecture provided in embodiments of the disclosure.

FIG. 2 is a schematic diagram illustrating overlapping of synchronization signal and physical broadcast channel (PBCH) block (SSB) measurement timing configurations (SMTCs) and measurement gaps (MGs) provided in an embodiment of the disclosure.

FIG. 3A is a schematic diagram illustrating a network control small gap (NCSG) provided in an embodiment of the disclosure.

FIG. 3B is a schematic diagram illustrating an NCSG provided in another embodiment of the disclosure.

FIG. 4 is a schematic diagram illustrating a method for measurement-occasion determination provided in an embodiment of the disclosure.

FIG. 5 is a schematic structural block diagram of a terminal device provided in an embodiment of the disclosure.

FIG. 6 is a schematic structural block diagram of a terminal device provided in another embodiment of the disclosure.

FIG. 7 is a schematic block diagram of a communication device provided in embodiments of the disclosure.

FIG. 8 is a schematic block diagram of a chip provided in embodiments of the disclosure.

FIG. 9 is a schematic block diagram of a communication system provided in embodiments of the disclosure.

### DETAILED DESCRIPTION

The following will illustrate technical solutions of embodiments of the disclosure with reference to accompanying drawings of embodiments of the disclosure.

The technical solutions in embodiments of the disclosure can be applicable to various communication systems, for example, a global system of mobile communication (GSM), a code division multiple access (CDMA) system, a wideband code division multiple access (WCDMA) system, a general packet radio service (GPRS) system, a long term evolution (LTE) system, an advanced LTE (LTE-A) system, a new radio (NR) system, an evolved system of the NR system, an LTE-based access to unlicensed spectrum (LTE-U) system, an NR-based access to unlicensed spectrum (NR-U) system, a non-terrestrial network (NTN) system, a universal mobile telecommunication system (UMTS), a wireless local area network (WLAN), a wireless fidelity (Wi-Fi), a 5th-generation (5G) system, or other communication systems.

Generally speaking, a conventional communication system supports a limited number of connections and therefore is easy to implement. However, with development of communication technology, a mobile communication system not only supports conventional communication but also supports, for example, device to device (D2D) communication, machine to machine (M2M) communication, machine type communication (MTC), and vehicle to vehicle (V2V) communication. Embodiments herein can also be applicable to these communication systems.

Optionally, a communication system in embodiments of the disclosure can be applicable to a carrier aggregation (CA) scenario, a dual connectivity (DC) scenario, and a standalone (SA) scenario.

In embodiments of the disclosure, each embodiment is illustrated with respective to a terminal device, where the terminal device may also be called a user equipment (UE), an access terminal, a subscriber unit, a subscriber station, a mobile station, a mobile platform, a remote station, a remote terminal, a mobile device, a user terminal, a terminal, a wireless communication device, a user agent, a user apparatus, etc.

The terminal device may also be a station (ST) in the WLAN, a cellular radio telephone, a cordless telephone, a session initiation protocol (SIP) telephone, a wireless local loop (WLL) station, a personal digital assistant (PDA). The terminal device may also be a device with wireless communication functions such as a handheld device, a computing device, other processing devices coupled with a wireless modem, an in-vehicle device, a wearable device, or a terminal device in a next-generation communication system such as an NR network, a terminal device in a future evolved public land mobile network (PLMN), etc.

In embodiments of the disclosure, the terminal device can be deployed on land, including indoor or outdoor, handheld, wearable, or vehicle-mounted; on water (e.g., a ship); and also in the air (e.g., an aircraft, a balloon, and a satellite).

In embodiments of the disclosure, the terminal device may be a mobile phone, a pad, a computer with wireless transceiving functions, a terminal device for virtual reality (VR), a terminal device for augmented reality (AR), a wireless terminal device in industrial control, a wireless terminal device in self driving, a wireless terminal device in remote medical, a wireless terminal device in smart grid, a wireless terminal device in transportation safety, a wireless terminal device in smart city, a wireless terminal device in smart home, etc.

As an example but not limitation, in embodiments of the disclosure, the terminal device may also be a wearable device. The wearable device can also be called a wearable smart device, which is a collective name of wearable devices intelligently designed and developed by applying a wearable technology to daily wear, such as glasses, gloves, watches, clothing, shoes, etc. The wearable device is a portable device that can be worn directly on the body or integrated into clothing or accessories of a user. The wearable device not only is a hardware device but also can realize powerful functions through software support, data interaction, and cloud interaction. Broadly speaking, the wearable smart device includes a device that has full functions and a large size and can realize all or part of functions without relying on a smart phone, e.g., a smart watch, smart glasses, or the like, and includes a device that only focuses on a certain application function and needs to be used with other devices such as a smart phone, e.g., all kinds of smart bracelets and smart jewelry for physical sign monitoring or the like.

In embodiments of the disclosure, the communication system may further include a network device. The network device may be a device that is used to communicate with a mobile device. The network device may be an access point (AP) in the WLAN, a base transceiver station (BTS) in the GSM or CDMA system, a NodeB (NB) in the WCDMA system, or an evolved NodeB (eNB or eNodeB) in the LTE system. Alternatively, the network device may also be a relay station, an AP, an in-vehicle device, a wearable device, a network device (a generation NodeB (gNB)) in the NR network, or a network device in the future evolved PLMN.

As an example but not limitation, in embodiments of the disclosure, the network device can have a mobility, e.g., the network device may be a mobile device. Optionally, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. Optionally, the network device may also be a base station deployed on land, on water, or on other locations.

In embodiments of the disclosure, the network device can provide a service for a cell, and the terminal device can communicate with the network device through transmission resources (e.g., frequency-domain resources or spectrum resources) for the cell, where the cell may be a cell corresponding to the network device (e.g., a base station). The cell may belong to a macro base station or a base station corresponding to a small cell, where the small cell may include a metro cell, a micro cell, a pico cell, a femto cell, or the like. These small cells have features of small coverage ranges and low transmission power and are suitable for providing high-speed data transmission services.

FIG. 1 exemplarily illustrates a communication system 1000. The communication system 1000 includes a network device 1100 and two terminal devices 1200. Optionally, the communication system 1000 may include multiple network devices 1100, and the other number of terminal devices may be included in a coverage range of each of the multiple network devices 1100, which is not limited in embodiments of the disclosure. Optionally, the communication system 1000 illustrated in FIG. 1 may further include a mobility management entity (MME), an access and mobility management function (AMF), or other network entities, which is not limited in embodiments of the disclosure.

It can be understood that, a device with a communication function in a network/system in embodiments of the disclosure can be called a communication device. Taking the communication system illustrated in FIG. 1 as an example, communication devices may include the network device and the terminal device that have communication functions, and the network device and the terminal device may be the specific devices in embodiments of the disclosure, which will not be repeated herein. The communication devices may further include other devices in the communication system, e.g., a network controller, an MME, or other network entities, which is not limited in embodiments of the disclosure.

It can be understood that, the terms “system” and “network” in this disclosure are often used interchangeably. The term “and/or” in this disclosure is an illustration of an association relationship of associated objects, for example, indicating that three relationships may exist between the associated objects, for example, A and/or B, which may indicate the existence of A alone, A and B together, and B alone. The character “/” in this disclosure generally indicates that associated objects are in an “or” relationship.

It can be understood that, the “indication” referred to in embodiments of the disclosure may be a direct indication, an indirect indication, or an indication indicating an associated relation. For example, A indicates B, which can mean that A indicates B directly, e.g., B can be obtained through A, can also mean that A indicates B indirectly, e.g., A indicates C, and B can be obtained through C, or can further mean that A and B have an associated relation.

In illustration of embodiments of the disclosure, the term “correspondence” may represent a direct correspondence or indirect correspondence between the two, may also represent an associated relation between the two, or may further represent a relation of indicating and being indicated, a relation of configuring and being configured, or other relations.

In order to facilitate understanding of the technical solutions of embodiments of the disclosure, the following describes the related technologies of embodiments of the disclosure. The related technologies below as an optional solution may be arbitrarily combined with the technical solutions of embodiments of the disclosure, and any combination thereof may belong to the scope of protection of embodiments of the disclosure.

(I) How to determine whether a measurement object (MO) is to be measured within a measurement gap (which may be referred to as an MG or gap hereinafter).

In the related art, the following factors need to be considered for determination of a measurement period of a certain MO.

1. Whether an MG is needed for measurement of an MO is determined according to a characteristic of the MO and capability of UE. The characteristic of the MO may include, for example, whether an intra-frequency measurement or an inter-frequency measurement is to be conducted on the MO, a relationship between a bandwidth (BW) of the MO and an active bandwidth part (BWP) of the UE, a relationship between a sub-carrier space (SCS) of the MO and the BWP of the UE, etc.

2. Whether measurement is actually to be conducted within an MG is determined according to a time-domain position of the MO, and/or the capability of the UE, and/or network signaling, etc. The time-domain position (or referred to as a measurement timing window) of the MO may be, for example, a synchronization signal and physical broadcast channel (PBCH) block (SSB) measurement timing configuration (SMTC) or a measurement window of a channel state information-reference signal (CSI-RS) resource. The capability of the UE may be, for example, whether the UE needs to conduct measurement within a gap (the UE may have a capability for intra-frequency measurement and a capability for inter-frequency measurement, for example, the capability for intra-frequency measurement is indicated via intraFreq-needForGap), whether the UE supports CA, etc. The network signaling, for example, indicates whether no MG (no-gap) is allowed.

Specifically, at first, whether an MG is needed for an MO (for example, an intra-frequency SSB, an inter-frequency SSB, an intra-frequency CSI-RS, an inter-frequency CSI-RS, etc.) is determined according to the following table 1.

TABLE 1
whether an MG is needed for an MO is determined

| | |
|---|---|
| Intra- | The UE can perform intra-frequency SSB based measurements without |
| frequency | measurement gaps if |
| SSB | the UE indicates ‘no-gap’ for intra-frequency measurement, or |
| | the SSB is completely contained in the active BWP of the UE, or |
| | the active downlink BWP is an initial BWP. |
| Inter- | The UE can perform inter-frequency SSB based measurements without |
| frequency | measurement gaps if |
| SSB | the UE indicates ‘no-gap’ for inter-frequency measurement, and |
| | the network device indicates that no MG is needed for inter- |
| | frequency measurement, and |
| | the SSB is completely contained in the active BWP of the UE. |
| Intra- | A measurement is defined as a CSI-RS based intra-frequency measurement |
| frequency | provided that: |
| CSI-RS | the SCS of the CSI-RS resource of the neighbour cell configured for |
| | measurement is the same as the SCS of the CSI-RS resource on the |
| | serving cell indicated for measurement, and |
| | the CP type of the CSI-RS resource of neighbour cell configured for |
| | measurement is the same as the CP type of the CSI-RS resource of |
| | the serving cell indicated for measurement, and |
| | It is applied for SCS = 60 KHzs |
| | the centre frequency of the CSI-RS resource of the neighbour cell |
| | configured for measurement is the same as the centre frequency of |
| | the CSI-RS resource of the serving cell indicated for measurement |
| | No measurement gap is needed for intra-frequency CSI-RS resources |
| | measurements. |
| Inter- | A measurement is defined as a CSI-RS based inter-frequency measurement |
| frequency | provided it is not defined as an intra-frequency measurement. |
| CSI-RS | The measurement gap is needed for inter-frequency CSI-RS resources |
| | measurements. |

Then, whether an MO is to be actually measured within MGs or outside MGs is determined according to table 2.

TABLE 2
whether an MO is to be actually measured within MGs is determined

| | |
|---|---|
| outside | The carrier-specific scaling factor CSSF_{outside}_{_{—}}_{gap, i} for measurement object i to be |
| MGs | measured outside an MG is applied to following measurement types: |
| | SSB-based intra-frequency measurement with no measurement gap, when |
| | none of the SMTC occasions of the SSB are overlapped by the measurement |
| | gap. |
| | SSB-based intra-frequency measurement with no measurement gap, when |
| | part of the SMTC occasions of the SSB are overlapped by the measurement |
| | gap (i.e., another part of the SMTC occasions are overlapped by no |
| | measurement gap). |
| | SSB-based inter-frequency measurement with no measurement gap, when |
| | none of the SMTC occasions of the SSB are overlapped by the measurement |
| | gap. |
| | SSB-based inter-frequency measurement with no measurement gap, when |
| | part of the SMTC occasions of the SSB are overlapped by the measurement |
| | gap, if it is a CA capable UE and both this UE capability and the network |
| | signaling support inter-frequency measurement with no measurement gap. |
| | CSI-RS based intra-frequency measurement with no measurement gap, when |
| | none of CSI-RS resources for layer-3 (L3) measurement are overlapped by |
| | the measurement gap. |
| | CSI-RS based intra-frequency measurement with no measurement gap, when |
| | all CSI-RS resources for L3 measurement are partially overlapped by the |
| | measurement gap. |
| | UE is expected to conduct the measurement of this measurement object i only |
| | outside the measurement gaps. |
| within | The carrier-specific scaling factor CSSF_{within}_{_{—}}_{gap, i} for measurement within MGs is |
| MGs | applied to following measurement types: |
| | SSB-based intra-frequency measurement object with no measurement gap, |
| | when all of the SMTC occasions of the SSB are overlapped by the |
| | measurement gap. |
| | SSB-based intra-frequency measurement object with measurement gaps. |
| | SSB-based inter-frequency measurement object with no measurement gap, |
| | when all of the SMTC occasions of the SSB are overlapped by the |
| | measurement gap. |
| | SSB-based inter-frequency measurement object with no measurement gap, |
| | when part of the SMTC occasions of the SSB are overlapped by the |
| | measurement gap, if it is not a CA capable UE. |
| | SSB-based inter-frequency measurement object with measurement gaps. |
| | . . . . . . |
| | UE is expected to conduct the measurement of this measurement object i only |
| | within measurement gaps. |

Taking SSB-based measurement as an example, as illustrated in table 2, whether the measurement is to be actually conducted within MGs or outside MGs is determined according to an overlapping relationship between SMTC and MGs.

(1) For SSB-based intra-frequency measurement with no MG (no-gap), the overlapping relationship between SMTC and MGs is determined. If SMTC is fully non-overlapping with MGs, measurement is to be conducted outside MGs. If SMTC is partially overlapping with MGs, measurement is to be conducted outside MGs, and although part of the SMTC is overlapping with MGs, measurement cannot be conducted within MGs overlapping with the part of the SMTC. If SMTC is fully overlapping with MGs, measurement is to be conducted within MGs.

(2) For SSB-based intra-frequency measurement with MGs, the measurement can be conducted only within MGs.

(3) For SSB-based inter-frequency measurement with no MG (no-gap), the overlapping relationship between SMTC and MGs is determined. If SMTC is fully non-overlapping with MGs and both the capability of the UE and network signaling support measurement with no MG, the measurement can be conducted only outside MGs. If SMTC is partially overlapping with MGs, the UE has CA capability, and both the capability of the UE and network signaling support measurement with no MG, the measurement is to be conducted outside MGs. If SMTC is partially overlapping with MGs and the UE does not have CA capability, the measurement is to be conducted within MGs. If SMTC is fully overlapping with MGs, the measurement can be conducted only within MGs.

(4) For SSB-based inter-frequency measurement with MGs, the measurement can be conducted only within MGs.

### (II) Measurement-Period Calculation

A difference between measurement-period calculation for frequency range (FR) 1 operating band-based intra-frequency measurement conducted outside MGs and measurement-period calculation for FR1 operating band-based intra-frequency measurement conducted within MGs is illustrated by taking a time period for primary synchronization signal (PSS)/secondary synchronization signal (SSS) detection in a cell identification process as an example. Times required for other measurement processes may be calculated in similar calculation manners, basically, measurement period =the number of sampling points x basic time unit x carrier specific scaling factor (CSSF). The basic time unit may be related to a signal period, a period of a measurement window, a discontinuous reception (DRX) cycle, an MG period, etc.

It may be noted that, in an L3 measurement process, such as FR2 operating band-based measurement, SSB-based inter-frequency measurement, and CSI-RS measurement, measurement-period calculation is similar to the above, which is not repeated herein.

### 1. Intra-Frequency Measurement With No MG

TABLE 3
time period for PSS/SSS detection [FR1]

| DRX cycle | T_{PSS/SSS}_{_{—}}_{sync}_{_{—}}ᵢₙₜᵣₐ |
|---|---|
| No DRX | max (600 ms, ceil(5 × Kₚ) × SMTC period)^{Note 1} × |
| | CSSFᵢₙₜᵣₐ, where ceil represents rounding up |
| DRX cycle ≤ 320 ms | max (600 ms, ceil(M2^{Note 2} × 5 × Kₚ) × max (SMTC |
| | period, DRX cycle)) × CSSFᵢₙₜᵣₐ |
| DRX cycle > 320 ms | ceil (5 × Kₚ) × DRX cycle × CSSFᵢₙₜᵣₐ |

NOTE 1:
If different SMTC periods are configured for different cells, the SMTC period in the requirement is the one used by the cell being identified
NOTE 2:
When highSpeedMeasFlag-r16 is not configured, M2 = 1.5; When highSpeedMeasFlag-r16 is configured, M2 = 1.5 if SMTC period > 40 ms; otherwise M2 = 1.
NOTE 3:
When highSpeedMeasFlag-r16 is configured, the requirements apply only to measurements of the primary component carrier and do not apply to measurements of a secondary component carrier with active SCell.

The basic time unit of measurement with no MG is related to an SMTC period, a DRX cycle, max(SMTC period, DRX cycle), etc.

CSSFᵢₙₜᵣₐ for intra-frequency measurement is calculated in two cases, i.e., a case where measurement is to be conducted outside MGs and a case where measurement is to be conducted within MGs.

(1) It is a carrier specific scaling factor and is determined according to CSSF_{outside_gap,i} in a protocol for measurement conducted outside MGs, i.e. when intra-frequency SMTC is fully non-overlapping or partially overlapping with MGs.

(2) Alternatively, it is a carrier specific scaling factor and is determined according to CSSF_{within_gap,i} in the protocol for measurement conducted within MGs, i.e. when intra-frequency SMTC is fully overlapping with MGs.

Kₚ is calculated in a manner as follows.

(1) When intra-frequency SMTC is fully non-overlapping with MGs or intra-frequency SMTC is fully overlapping with MGs, Kₚ=1.

(2) When intra-frequency SMTC is partially overlapping with MGs, Kₚ=1/(1-(SMTC period/MGRP)), where SMTC period<MGRP, and MGRP is a measurement gap repetition period.

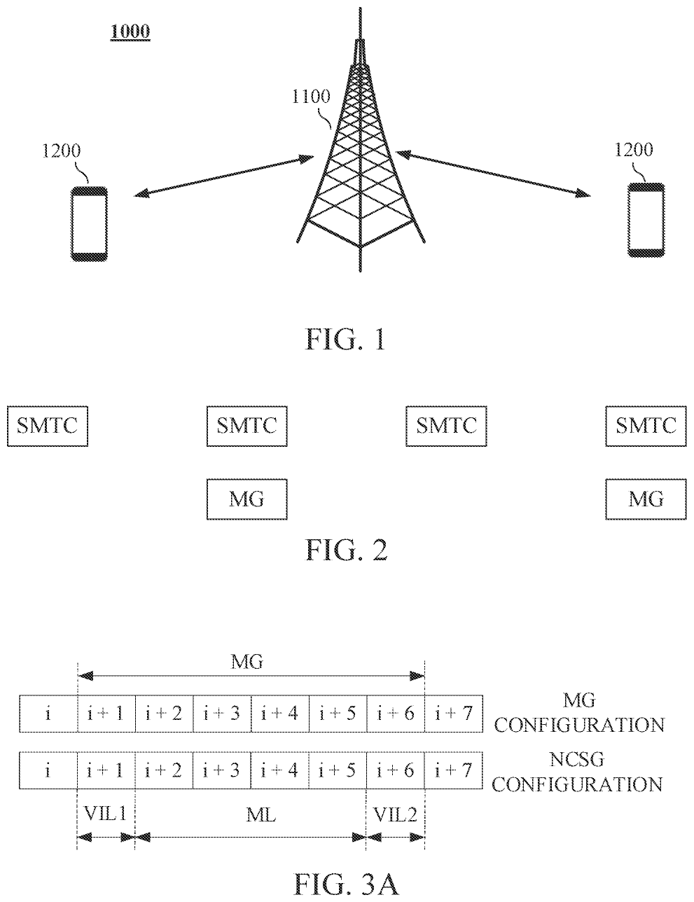

That is to say, Kₚ=1 under normal conditions, and part of SMTC overlapping with MGs may be removed in the case where SMTC is partially overlapping with MGs (in case of measurement with no MG). As illustrated in FIG. 2, assuming that MGRP is twice SMTC period (SMTC period/MGRP=½), half of SMTC occasions may be overlapping with MGs. Since an SSB can be measured only outside MGs in this case, part of the SSB within MGs cannot be measured, and thus Kₚ=2 is needed to double a total measurement time.

### 2. Intra-Frequency Measurement With MGs

TABLE 4
time period for PSS/SSS detection (FR1)

| DRX cycle | T_{PSS/SSS}_{_{—}}_{sync}_{_{—}}ᵢₙₜᵣₐ |
|---|---|
| No DRX | max(600 ms, 5 × max(MGRP, SMTC period)) × |
| | CSSFᵢₙₜᵣₐ |
| DRX cycle ≤ 320 ms | max(600 ms, ceil(M2^{Note 1} × 5) × max(MGRP, |
| | SMTC period, DRX cycle)) × CSSFᵢₙₜᵣₐ |
| DRX cycle > 320 ms | 5 × max(MGRP, DRX cycle) × CSSFᵢₙₜᵣₐ |

NOTE 1:
When highSpeedMeasFlag-r16 is not configured, M2 = 1.5; When highSpeedMeasFlag-r16 is configured, M2 = 1.5 if SMTC period > 40 ms, otherwise M2 = 1.
NOTE 2:
When highSpeedMeasFlag-r16 is configured, the requirements apply only to measurements of the primary component carrier and do not apply to measurements of a secondary component carrier with active SCell.

The basic time unit for measurement conducted within MGs is related to an SMTC period, a DRX cycle, and an MGRP.

CSSFᵢₙₜᵣₐ for intra-frequency measurement in table 4 is a carrier specific scaling factor and is determined according to CSSF_{within_gap,i} in the protocol in the case where measurement is to be conducted within MGs, for example, in the case where the intra-frequency SMTC is fully overlapping with MGs.

An MO which needs to be measured within MGs can be measured only within MGs, and thus only CSSF_{within_gap,i} corresponding to measurement conducted within MGs is calculated. The basic time unit for period calculation is determined according to a maximum value between SMTC and MGRP, and thus it is no longer necessary to introduce scaling factor Kₚ for the case of partial overlapping.

### (III) CSSF Calculation

As described above, there may be CSSF_{within_gap,i} and CSSF_{outside_gap,i} according to whether measurement is to be conducted within MGs. Specifically, CSSF_{within_gap,i} and CSSF_{outside_gap,i} may be calculated according to different operation scenarios of the terminal device, for example, SA, evolved UTRA-NR (EUTRA-NR) dual connection (EN-DC), NR-DC, and so on. Herein, an SA scenario is simply taken as an example for illustration.

For CSSF calculation for measurement conducted outside MGs (outside gaps), the number of different serving carriers and the number of inter-frequency MOs may be considered.

For CSSF calculation for measurement conducted within MGs (within gaps), the number of all MOs to-be-measured within MG occasions may be considered. Optionally, a CSSF for an intra-frequency MO and a CSSF for an inter-frequency MO may be further determined according to gap sharing ratios indicated by the network.

1. CSSF_{outside_gap,i} calculation for measurement conducted outside gaps in SA scenario is as follows.

CSSF calculation for measurement conducted outside gaps is mainly related to the number of carriers and the number of inter-frequency MOs. A CSSF for primary carrier components (PCCs) needs to be determined according to the number of PCCs. A CSSF for secondary carrier components (SCCs) needs to be determined according to the number of SCCs and the number of inter-frequency MOs. The details are illustrated in table 5.

TABLE 5
CSSF_{outside}_gap, i of the UE for SA mode

| | | | | CSSF_{outside}_gap, i for FR2 |
|---|---|---|---|---|
| | CSSF_{outside}_gap, i | CSSF_{outside}_gap, i | CSSF_{outside}_gap, i | SCC where neighbour cell |
| Scenario | for FR1 PCC | for FR1 SCC | for FR2 PCC | measurement is required |
| FR1 only CA | 1 + N_{PCC}_CSIRS | N_{SCC}_SSB + Y + | N/A | N/A |
| | | 2 × N_{SCC}_CSIRS | | |
| FR2 only | N/A | N/A | 1 + N_{PCC}_CSIRS | N/A |
| intra band CA | | | | |
| FR2 only | N/A | N/A | 1 | 2*(1 + |
| inter band CA | | | | N_{SCC}_CSIRS_FR2_NCM) ^{Note 3, 5} |
| FR1 + | 1 + N_{PCC}_CSIRS | 2 × (N_{SCC}_SSB + | N/A | 2 × (1 + |
| FR2 CA (FR1 | | Y + 2* N_{SCC}_CSIRS − | | N_{SCC}_CSIRS_FR2_NCM) ^{Note 3, 5} |
| PCell) ^{Note 1} | | 1 − N_{SCC}_CSIRS_FR2_NCM) | | |

| | CSSF_{outside}_gap, i for FR2 | CSSF_{outside}_gap, i |
|---|---|---|
| | SCC where neighbour cell | for inter-frequency MO |
| Scenario | measurement is not required | with no measurement gap |
| FR1 only CA | N/A | N_{SCC}_SSB + Y + |
| | | 2 × N_{SCC}_CSIRS |
| FR2 only | N_{SCC}_SSB + Y + | N_{SCC}_SSB + Y + |
| intra band CA | 2 × N_{SCC}_CSIRS | 2 × N_{SCC}_CSIRS |
| FR2 only | 2 × (N_{SCC}_SSB + | 2 × (N_{SCC}_SSB + |
| inter band CA | Y + 2 × N_{SCC}_CSIRS − | Y + 2 × N_{SCC}_CSIRS − |
| | 1 − N_{SCC}_CSIRS_FR2_NCM) | 1 − N_{SCC}_CSIRS_FR2_NCM) |
| FR1 + | 2 × (N_{SCC}_SSB + | 2 × (N_{SCC}_SSB + |
| FR2 CA (FR1 | Y + 2 × N_{SCC}_CSIRS − | Y + 2 × N_{SCC}_CSIRS − |
| PCell) ^{Note 1} | 1 − N_{SCC}_CSIRS_FR2_NCM) | 1 − N_{SCC}_CSIRS_FR2_NCM) |

^{Note 1}:
Only one FRI operating band and one FR2 operating band are included for FR1 + FR2 inter-band CA.
Note 2:
Selection of FR2 SCC where neighbour cell measurement is required follows a related protocol.
^{Note 3}:
CSSF_{outside}_gap, i = 1 if only one cell is configured and no inter-frequency MO without gap.
Note 4:
Y is the number of configured inter-frequency MOs without MG that are being measured outside of MG for CA capable UE; otherwise, it is 0.
^{Note 5}:
Only two NR FR2 operating bands are included for FR2 inter-band CA.
Note 6:
N_{PCC}_CSIRS = 1 if PCC is with either both SSB and CSI-RS based L3 measurement configured or only CSI-RS based L3 measurement configured; otherwise, N_{PCC}_CSIRS = 0.
Note 7:
N_{SCC}_CSIRS = Number of configured cell(s) with either both SSB and CSI-RS based L3 measurement configured or only CSI-RS based L3 measurement configured
Note 8:
N_{SCC}_CSIRS_FR2_NCM = 1 if FR2 SCC, where neighbour cell measurement is required, is with either both SSB and CSI-RS configured or only CSI-RS measurement configured; otherwise, N_{SCC}_CSIRS_FR2_NCM = 0.
Note 9:
N_{SCC}_SSB = Number of configured SCell(s) with only SSB based L3 measurement configured

2. In the SA scenario, CSSF_{within_gap,i} for measurement conducted within gaps is calculated as follows.

The CSSF for measurement conducted within gaps is related to the number of MOs.

Furthermore, a CSSF for MO i, i.e., CSSF_{within_gap,i} is determined according to the number of intra-frequency MOs, M_{intra,i,j}, the number of inter-frequency MOs, M_{inter,i,j}, the number of all MOs, M_{tot,i,j}, the total number of NR positioning reference signal (PRS) measurements, etc. in each MG (denoted as MG j), where M_{tot,i,j}=M_{intra,i,j}+M_{inter,i,j}.

Furthermore, a sharing ratio for intra-frequency MOs and a sharing ratio for inter-frequency MOs may be allocated according to a sharing scheme indicated by the network. In particular, for each MG j used for a long-periodicity measurement defined above,

M_{intra,i,j}=M_{inter,i,j}=M_{tot,i,j}=0.

CSSF_{within_gap,i} is given by the following.

(1) If measGapSharingScheme is equal sharing, CSSF_{within gap,i}=max(ceil(Rᵢ×M_{tot,i,j})), where j=0 (160/MGRP)-1.

(2) If measGapSharingScheme is not equal sharing and further indicates intra-frequency ratio Kᵢₙₜᵣₐ and inter-frequency ratio Kᵢₙₜₑᵣ, and MO i is an intra-frequency MO, CSSF_{within_gap,i} is the maximum among: ceil(Rᵢ×Kᵢₙₜᵣₐ×M_{intra,i,j}) in gaps where M_{inter,i,j}≠0, where j=0 . . . (160/MGRP)-1; and ceil(Rᵢ×M_{intra,i,j}) in gaps where M_{inter,i,j}=0, where j=0 . . . (160/MGRP)-1. Alternatively, if measGapSharingScheme is not equal sharing and further indicates intra-frequency ratio Kᵢₙₜᵣₐ and inter-frequency ratio Kᵢₙₜₑᵣ, and MO i is an inter-frequency or inter-RAT MO or NR PRS measurement on any one frequency layer, CSSF_{within_gap,i} is the maximum among: ceil(Rᵢ×Kᵢₙₜₑᵣ×M_{inter,i,j}) in gaps where M_{intra,i,j}≠0, where j=0 . . . (160/MGRP)-1; and ceil(Rᵢ×M_{inter,i,j}) in gaps where M_{intra,i,j}=0 where j=0 . . . (160/MGRP)-1.

### (IV) NCSG

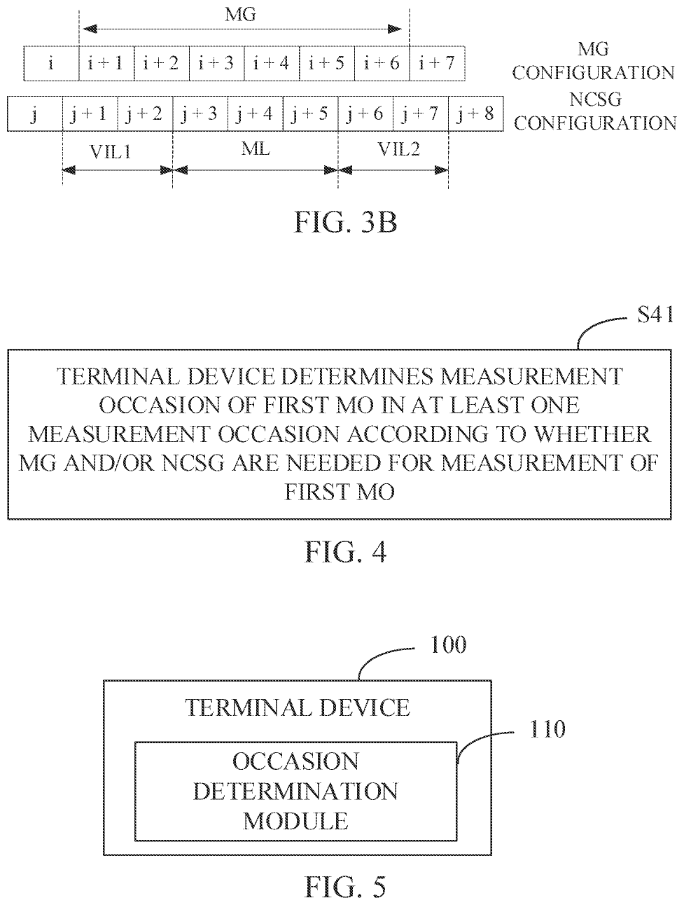

Measurement within MGs may interrupt data transmission. In order to shorten an interruption time caused by measurement, an NCSG is introduced in a communication system. FIG. 3A is a schematic diagram illustrating an exemplary MG configuration and an NCSG configuration in a synchronous scenario, and FIG. 3B is a schematic diagram illustrating an exemplary MG configuration and an NCSG configuration in an out-of-sync scenario. As illustrated in FIG. 3A and FIG. 3B, an MG includes the (i+1)th to (i+6)th sub-frames in the time domain, and thus interruption may occur in the 6 sub-frames. When an NCSG is used, a radio frequency (RF) link can be adjusted in only a visible interruption length (VIL) of the first sub-frame in the 6 sub-frames and a VIL of the last frame in the 6 sub-frames, e.g., VIL1 and VIL2 in FIG. 3A and VIL1 and VIL2 in FIG. 3B. Therefore, short interruption may occur only in a small number of sub-frames with VIL1 and VIL2. Measurement and data transceiving for a serving cell both can be maintained in a measurement length (ML), and thus the time in which data transmission is interrupted (hereinafter, data interruption time) can be effectively reduced while measurement is ensured. Obviously, whether the terminal device can support NCSGs is based on a capability of the terminal device, for example, based on whether the terminal device has an available RF resource.

At present, four types of NCSG patterns are defined in the LTE protocol. An NCSG pattern with a pattern identifier (ID) of x may be recorded as NCSG #x, and accordingly, an MG pattern with a pattern ID of y may be recorded as MG pattern #y. NCSG patterns may be in a correspondence with MG patterns, in other words, an NCSG pattern is derived from an MG pattern. As illustrated in table 6, NCSG #0 is derived from MG pattern #0 and applicable to a synchronous scenario as illustrated in FIG. 3A, and NCSG #2 is derived from MG pattern #0 and applicable to an out-of-sync scenario as illustrated in FIG. 3B. NCSG #1 is derived from MG pattern #1 and applicable to a synchronous scenario, and NCSG #3 is derived from MG pattern #1 and applicable to an asynchronous scenario. A visible interruption repetition period (VIRP) of an NCSG is equal to a repetition period of a corresponding MG, i.e., MGRP. The sum of VIL1, ML, and VIL2 in an NCSG pattern is equal to a length of a corresponding MG, i.e., a measurement gap length (MGL).

TABLE 6
NCSG Configuration

| | VIL before | ML during which | VIL after | |
|---|---|---|---|---|
| NCSG | measurement | there is no gap | measurement | VIRP |
| Pattern ID | (VIL1, ms) | (ML, ms) | (VIL2, ms) | (ms) |
| 0 | 1 | 4 | DL: 1 | 40 |
| | | | UL: 2 | |
| 1 | 1 | 4 | DL: 1 | 80 |
| | | | UL: 2 | |
| 2 | 2 | 3 | 2 | 40 |
| 3 | 2 | 3 | 2 | 80 |

However, at present, there is no solution for the following problems: whether an NCSG can be configured together with MGs after introduction of the NCSG, how to determine whether the terminal device is to conduct measurement outside gaps, within an NCSG, or within an MG during specific measurement, and how to calculate a CSSF in the case where measurement is to be conducted within an NCSG.

The solutions provided in embodiments of the disclosure are mainly used to solve at least one of the above problems.

In order for more comprehensive understanding of features and technical solutions of embodiments, the following will describe in detail embodiments with reference to the accompanying drawings. The accompanying drawings are merely intended for illustration rather than limitation on the disclosure.

FIG. 4 is a schematic flow chart illustrating a method for measurement-occasion determination according to an embodiment of the disclosure. The method may optionally be applied to the system illustrated in FIG. 1, but is not limited thereto. As illustrated in FIG. 4, the method includes at least part of the following.

At S41, the terminal device determines a measurement occasion of a first MO in at least one measurement occasion according to whether an MG and/or an NCSG are needed for measurement of the first MO, where the at least one measurement occasion includes the NCSG.

For example, the first MO may include an intra-frequency SSB, an inter-frequency SSB, an intra-frequency CSI-RS, an inter-frequency CSI-RS, etc.

Exemplarily, in embodiments of the disclosure, there may be an association relationship between an MO and an MG and an association relationship between an MO and an NCSG. That is, the first MO may correspond to a certain MG configuration or a certain NC SG configuration, and different MOs may correspond to different MG configurations or different NCSG configurations. Based on this, the NC SG in the at least one measurement occasion may be an NCSG corresponding to the first MO, and the MG may be an MG corresponding to the first MO.

Exemplarily, the terminal device may merely determine whether the MG is needed for the measurement of the first MO, may merely determine whether the NCSG is needed for the measurement of the first MO, or may determine whether both the MG and the NC SG are needed for the measurement of the first MO. Specifically, the terminal device can perform the above operation according to a system configuration.

Optionally, in the case where the system allows the measurement to be conducted within the MG and allows the measurement to be conducted with no MG and only within the NCSG, the terminal device may first determine whether the MG is needed for the measurement of the first MO, and then execute the operation at S41.

Optionally, in the case where the system allows the measurement to be conducted within the NCSG and outside the NCSG, the terminal device may first determine whether the NCSG is needed for the measurement of the first MO, and then execute the operation at S41.

Optionally, in the case where the system allows the measurement to be conducted within the NCSG, within the MG, and at an occasion outside both the MG and the NCSG, the terminal device may first determine whether the MG and the NCSG are needed for the measurement of the first MO, and then execute the operation at S41.

Exemplarily, the terminal device may determine whether the MG and/or the NCSG are needed for the measurement of the first MO according to a preset condition. The method provided in the embodiments of the disclosure may further include an operation that the terminal device determines whether the MG and/or the NCSG are needed for the measurement of the first MO according to the preset condition. There are several exemplary embodiments for the operation. In practical applications, one or more of the following may be selected.

Example 1: the terminal device determines whether the MG is needed for the measurement of the first MO according to a first condition.

An intra-frequency SSB is taken as an example of the first MO, and the first condition may include at least one of the following.

Condition 1: the terminal device supports conducting intra-frequency measurement outside MGs (namely, the terminal device supports conducting the measurement of the first MO outside the MG).

Condition 2: the first MO is completely contained in an active BWP.

Condition 3: an active downlink BWP is an initial BWP.

In the case where the first condition is met (at least one of the conditions 1 to 3 is met), the terminal device may determine that the MG is not needed, and that only the NCSG may be needed for the measurement. The terminal device may determine that the MG is needed in the case where the first condition is not met (none of the conditions 1 to 3 is met).

The exemplary manner may be adopted in the case where the system allows the measurement to be conducted within the MG and outside the MG, or in the case where the system allows the measurement to be conducted within the MG and within the NCSG. The NCSG can be understood as a special example of an occasion outside the MG.

Whether the measurement can be actually conducted outside the MG is related to a capability of the terminal device, a network configuration, a frequency type (intra-frequency or inter-frequency) of the first MO, a measurement timing window of the first MO, and other information. Therefore, in the case where the terminal device determines that the measurement of the first MO does not need to be conducted within the MG, the terminal device further determines whether the measurement is to be actually conducted within the MG or outside the MG according to other information. Exemplarily, in the case where the MG is needed for the measurement of the first MO, the terminal device can conduct the measurement only within the MG. In the case where the MG is not needed for the measurement of the first MO, the terminal device needs to determine an actual measurement occasion from the MG and occasions outside the MG, or determine the actual measurement occasion from the MG and the NCSG.

Example 2: the terminal device determines whether the NCSG is needed for the measurement of the first MO according to the first condition.

The intra-frequency SSB is taken as an example of the first MO, and the first condition may include at least one of the following.

Condition 1: the terminal device supports conducting intra-frequency measurement outside the NCSG.

Condition 2: the first MO is completely contained in an active BWP.

Condition 3: the active downlink BWP is an initial BWP.

The terminal device may determine that the NC SG is not needed in the case where the first condition is met (at least one of the conditions 1 to 3 is met). The terminal device may determine that the NCSG is needed in the case where the first condition is not met (none of the conditions 1 to 3 is met).

The exemplary manner may be adopted in the case where the system allows the measurement to be conducted within the NCSG and outside the NCSG. The NCSG can be understood as a special MG to replace the MG in the related art.

Optionally, in the case where the NCSG is needed for the measurement of the first MO, the terminal device can conduct the measurement only within the NCSG. In the case where the NCSG is not needed for the measurement of the first MO, the terminal device needs to determine the actual measurement occasion from the NCSG and occasions outside the NCSG according to the capability of the terminal device, the network configuration, the frequency type (intra-frequency or inter-frequency) of the first MO, the measurement timing window of the first MO, and other information.

Example 3: the terminal device determines whether the MG is needed for the measurement of the first MO according to the first condition, and determines whether the NCSG is needed for the measurement of the first MO according to a second condition in response to the MG being not needed for the measurement of the first MO.

The intra-frequency SSB is taken as an example of the first MO, and the first condition may include at least one of the following.

Condition 1: the terminal device supports conducting intra-frequency measurement outside the MG.

Condition 2: the first MO is completely contained in an active BWP.

Condition 3: an active downlink BWP is an initial BWP.

The terminal device may determine that the MG is not needed in the case where the first condition is met (at least one of the conditions 1 to 3 is met). The terminal device may determine that the MG is needed in the case where the first condition is not met (none of the conditions 1 to 3 is met).

Furthermore, the terminal device determines whether the NC SG is needed for the measurement of the first MO according to the second condition in the case where the terminal device determines that the MG is not needed. For example, the second condition includes condition 2 (the first MO is completely contained in the active BWP), and the terminal device determines that the NC SG is not needed for the measurement of the first MO in the case where the second condition is met. That is, in the case where at least one of the conditions 1 to 3 is met, both the MG and the NCSG are not needed for the measurement of the first MO (no gap at all) in response to the condition 2 being met (the first MO is completely contained in the active BWP), and the measurement may be conducted within the NCSG in response to condition 2 being not met, e.g., the first MO is before the BWP.

The exemplary manner may be adopted in the case where the system allows the measurement to be conducted within the NCSG, within the MG, and at the occasion outside both the MG and the NC SG (hereinafter “outside gaps”). The case that the terminal device needs no MG may mean that the terminal device supports no-gap. The NC SG may be considered as a special no-gap. No-gap includes two cases, i.e., no gap is needed (no MG and no NCSG are needed), and the NCSG is needed.

Optionally, the terminal device can conduct the measurement only within the MG in the case where the MG is needed for the measurement of the first MO. In the case where the MG is not needed for the measurement of the first MO and the NCSG is needed for the measurement of the first MO, the terminal device needs to determine the actual measurement occasion from the NCSG and the MG according to the capability of the terminal device, the network configuration, the frequency type (intra-frequency or inter-frequency) of the first MO, the measurement timing window of the first MO, etc. The terminal device may determine the actual measurement occasion from the MG, the NCSG, and the occasion outside gaps according to the above information in the case where both the MG and the NC SG are not needed for the measurement of the first MO.

Example 4: the terminal device determines whether the MG is needed for the measurement of the first MO according to the first condition, and determines whether the NCSG is needed for the measurement of the first MO according to a third condition in response to the MG being needed for the measurement of the first MO.

The intra-frequency SSB is taken as an example of the first MO, and the first condition may include at least one of the following.

Condition 1: the terminal device supports conducting intra-frequency measurement outside the MG.

Condition 2: the first MO is completely contained in an active BWP.

Condition 3: an active downlink BWP is an initial BWP.

The terminal device may determine that the MG is not needed in the case where the first condition is met (at least one of the conditions 1 to 3 is met). The terminal device may determine that the MG is needed in the case where the first condition is not met (none of the conditions 1 to 3 is met).

Furthermore, the terminal device determines whether the NC SG is needed for the measurement of the first MO according to the third condition in the case where the terminal device determines that the MG is needed. For example, the third condition includes that the UE supports an NCSG capability, that is, the terminal device supports conducting measurement within the NCSG and both the first MO and the active BWP are located in a same band, and the terminal device determines that the NCSG is needed for the measurement of the first MO in the case where the third condition is met. That is, in the case where none of the conditions 1 to 3 is met, the NCSG is needed for the measurement of the first MO in response to the third condition being met, and the MG is needed for the measurement of the first MO in the case where the third condition is not met.

The exemplary manner may be adopted in the case where the system allows the measurement to be conducted within the NCSG, within the MG, and outside gaps. The case that the terminal device needs no MG may mean that the terminal device supports complete no-gap (no MG and no NCSG are needed). The NCSG may be considered as a special MG. The terminal device further determines whether an NC SG with a short interruption time is needed in the case where the terminal device determines that the MG is needed.

Optionally, the terminal device can conduct the measurement only within the MG in the case where a complete MG is needed for the measurement of the first MO. The terminal device needs to determine the actual measurement occasion from the MG and the NCSG according to other information in the case where the MG is needed for the measurement of the first MO and the NC SG may also be needed for the measurement of the first MO. The terminal device may determine the actual measurement occasion from the MG, the NCSG, and the occasion outside gaps according to other information in the case where the MG is not needed for the measurement of the first MO.

It can be seen from the above examples that the operation at S41 that the terminal device determines the measurement occasion of the first MO in the at least one measurement occasion according to whether the MG and/or the NCSG are needed for the measurement of the first MO may specifically include the following. The terminal device determines the measurement occasion of the first MO in the at least one measurement occasion according to whether the MG and/or the NCSG are needed for the measurement of the first MO, and at least one of: the capability of the terminal device, the network configuration, the frequency type (intra-frequency or inter-frequency) of the first MO, or the measurement timing window of the first MO.

The following may specifically describe how the terminal device determines the actual measurement occasion for different requirements.

Optionally, in the case where the communication system allows the measurement to be conducted within the NC SG and outside gaps, or in the case where the communication system allows the measurement to be conducted within the MG, within the NCSG, and outside gaps but the network device configures that the terminal device can conduct the measurement only within the NCSG and outside gaps, the operation that the terminal device determines whether the NC SG is needed for the measurement of the first MO includes processing for at least one of the following.

Case 1: the NCSG is not needed for the measurement of the first MO.

Case 2: the NCSG is needed for the measurement of the first MO.

Specifically, the terminal device determines the measurement occasion of the first MO in the at least one measurement occasion according to whether the NCSG is needed for the measurement of the first MO. The terminal device determines the measurement occasion of the first MO from the occasion outside gaps and the NCSG according to a position relationship between the measurement timing window of the first MO and the NCSG, in response to the NCSG being not needed for the measurement of the first MO (case 1). The terminal device determines that the measurement occasion of the first MO is the NCSG in response to the NCSG being needed for the measurement of the first MO (case 2).

Optionally, for case 1, the terminal device determines the measurement occasion of the first MO from the occasion outside gaps and the NCSG according to the position relationship between the measurement timing window of the first MO and the NCSG as follows. The terminal device determines that the measurement occasion of the first MO is the occasion outside gaps in response to the measurement timing window of the first MO being fully non-overlapping with the NCSG; and/or, the terminal device determines that the measurement occasion of the first MO is the NC SG in response to the measurement timing window of the first MO being fully overlapping with the NCSG; and/or, the terminal device determines the measurement occasion of the first MO from the occasion outside gaps and the NCSG according to at least one of the frequency type of the first MO, the capability of the terminal device, or network signaling, in response to the measurement timing window of the first MO being partially overlapping with the NCSG.

Exemplarily, in the case where the measurement timing window of the first MO is partially overlapping with the NCSG, the terminal device determines that the measurement occasion of the first MO is the occasion outside gaps, in response to the first MO being an intra-frequency MO, or in response to the first MO being an inter-frequency MO and the terminal device having a CA capability and both the capability of the terminal device and the network signaling supporting measurement outside gaps; otherwise, the terminal device determines that the measurement occasion of the first MO is the NCSG.

Optionally, in the case where the communication system allows measurement to be conducted within the NCSG and within the MG, or in the case where the communication system allows measurement to be conducted within the MG, within the NCSG, and outside gaps but the network device configures that the terminal device can conduct measurement only within the NCSG and within the MG, the operation that the terminal device determines whether the MG is needed for the measurement of the first MO includes processing for at least one of the following.

Case 3: the MG is not needed for the measurement of the first MO.

Case 4: the MG is needed for the measurement of first MO.

Specifically, the terminal device determines the measurement occasion of the first MO in the at least one measurement occasion according to whether the MG is needed for the measurement of the first MO as follows. The terminal device determines the measurement occasion of the first MO from the NCSG and the MG according to the position relationship among the measurement timing window of the first MO, the NCSG, and the MG, in response to the MG being not needed for the measurement of the first MO (case 3); and/or, the terminal device determines that the measurement occasion of the first MO is the MG, in response to the MG being needed for the measurement of the first MO (case 4).

Optionally, for case 3, the terminal device determines the measurement occasion of the first MO from the NC SG and the MG according to the position relationship among the measurement timing window of the first MO, the NCSG, and the MG as follows. The terminal device determines that the measurement occasion of the first MO is the NCSG, in response to the measurement timing window of the first MO being at least partially overlapping with the NCSG and being fully non-overlapping with the MG; and/or, the terminal device determines that the measurement occasion of the first MO is the MG, in response to the measurement timing window of the first MO being fully non-overlapping with the NCSG and being at least partially overlapping with the MG; and/or, the terminal device determines the measurement occasion of the first MO from the NC SG and the MG according to at least one of the frequency type of the first MO, the capability of the terminal device, or the network signaling, in response to the measurement timing window of the first MO being partially overlapping with the NCSG and being partially overlapping with the MG.

Exemplarily, in response to the measurement timing window of the first MO being partially overlapping with the NCSG and being partially overlapping with the MG, the terminal device may measure the first MO only within the MG or only within the NCSG, or determine whether to conduct the measurement of the first MO within the NCSG or within the MG according to the configuration of the first MO in combination with the capability of the terminal device, network signaling, etc.

Optionally, in the case where the communication system allows measurement to be conducted within the NCSG, within the MG, and outside gaps, and further optionally, the network device configures that the terminal device can conduct measurement within the NCSG, within the MG, and outside gaps, the operation that the terminal device determines whether the MG and the NC SG are needed for the measurement of the first MO includes processing for at least one of the following.

Case 5: both the MG and the NCSG are not needed for the measurement of the first MO.

Case 6: the MG is not needed for the measurement of the first MO and the NC SG is needed for the measurement of the first MO.

Case 7: the MG is needed for the measurement of the first MO.

Specifically, the terminal device determines the measurement occasion of the first MO in the at least one measurement occasion according to whether the MG and/or the NCSG are needed for the measurement of the first MO as follows. The terminal device determines the measurement occasion of the first MO from the occasion outside gaps, the NCSG, and the MG according to the position relationship among the measurement timing window of the first MO, the NCSG, and the MG, in response to both the MG and the NC SG being not needed for the measurement of the first MO (case 5); and/or, the terminal device determines the measurement occasion of the first MO from the NCSG and the MG according to the position relationship among the measurement timing window of the first MO, the NCSG, and the MG, in response to the MG being not needed for the measurement of the first MO and the NCSG being needed for the measurement of the first MO (case 6); and/or, the terminal device determines that the measurement occasion of the first MO is the MG, in response to the MG being needed for the measurement of the first MO (case 7).

Optionally, for case 5, the terminal device determines the measurement occasion of the first MO from the occasion outside gaps, the NCSG, and the MG according to the position relationship among the measurement timing window of the first MO, the NCSG, and the MG as follows. The terminal device determines the measurement occasion of the first MO from the occasion outside gaps and the MG according to the position relationship between the measurement timing window of the first MO and the MG, in response to the measurement timing window of the first MO being fully non-overlapping with the NCSG (case 5.1); and/or, the terminal device determines the measurement occasion of the first MO from the occasion outside gaps and the NC SG according to the position relationship between the measurement timing window of the first MO and the NCSG, in response to the measurement timing window of the first MO being fully non-overlapping with the MG (case 5.2); and/or, the terminal device determines the measurement occasion of the first MO from the occasion outside gaps, the NCSG, and the MG according to whether the measurement timing window of the first MO contains a first time range, in response to the measurement timing window of the first MO being partially overlapping with the MG and being partially overlapping with the NC SG (case 5.3). The first time range is non-overlapping with both the MG and the NCSG.

Exemplarily, for that the terminal device determines the measurement occasion of the first MO from the occasion outside gaps and the MG according to the position relationship between the measurement timing window of the first MO and the MG, in response to the measurement timing window of the first MO being fully non-overlapping with the NCSG (case 5.1), reference may be made to the illustration of table 2 in the related art (I).

Exemplarily, for that the terminal device determines the measurement occasion of the first MO from the occasion outside gaps and the NCSG according to the position relationship between the measurement timing window of the first MO and the NCSG, in response to the measurement timing window of the first MO being fully non-overlapping with the MG (case 5.2), reference may be made to the processing for case 1. Specifically, the terminal device determines the measurement occasion of the first MO from the occasion outside gaps and the NCSG according to the position relationship between the measurement timing window of the first MO and the NC SG as follows. The terminal device determines that the measurement occasion of the first MO is the occasion outside gaps, in response to the measurement timing window of the first MO being fully non-overlapping with the NCSG; and/or, the terminal device determines that the measurement occasion of the first MO is the NCSG, in response to the measurement timing window of the first MO being fully overlapping with the NCSG; and/or, the terminal device determines the measurement occasion of the first MO from the occasion outside gaps and the NCSG according to at least one of the frequency type of the first MO, the capability of the terminal device, or the network signaling, in response to the measurement timing window of the first MO being partially overlapping with the NCSG.

Exemplarily, in response to the measurement timing window of the first MO being partially overlapping with the MG and being partially overlapping with the NCSG (case 5.3), the terminal device determines the measurement occasion of the first MO from the occasion outside gaps, the NCSG, and the MG according to whether the measurement timing window of the first MO contains the first time range that is non-overlapping with both the MG and the NCSG as follows. The terminal device determines the measurement occasion of the first MO from the occasion outside gaps, the NCSG, and the MG, in response to the measurement timing window of the first MO containing the first time range; and/or, the terminal device determines the measurement occasion of the first MO from the NCSG and the MG, in response to the measurement timing window of the first MO not containing the first time range.

Optionally, for case 6, the terminal device determines the measurement occasion of the first MO from the NC SG and the MG according to the position relationship between the measurement timing window of the first MO, the NCSG, and the MG as follows. The terminal device determines that the measurement occasion of the first MO is the NCSG, in response to the measurement timing window of the first MO being at least partially overlapping with the NCSG and being fully non-overlapping with the MG; and/or, the terminal device determines the measurement occasion of the first MO is the MG, in response to the measurement timing window of the first MO being fully non-overlapping with the NCSG and being at least partially overlapping with the MG; and/or, the terminal device determines the measurement occasion of the first MO from the NC SG and the MG according to at least one of the frequency type of the first MO, the capability of the terminal device, or the network signaling, in response to the measurement timing window of the first MO being partially overlapping with the NCSG and being partially overlapping with the MG.

Exemplarily, in response to the measurement timing window of the first MO being partially overlapping with the NCSG and being partially overlapping with the MG, the terminal device may measure the first MO only within the MG or only within the NCSG, or determine whether to conduct the measurement of the first MO within the NC SG or within the MG according to the configuration of the first MO in combination with the capability of the terminal device, network signaling, etc.

In some embodiments of the disclosure, in the case where the measurement timing window (for example, the SMTC) of the first MO is partially overlapping with the MG and/or the NCSG, to calculate a measurement period of the first MO, the terminal device needs to calculate scaling factor Kₚ (hereinafter referred to as a first specific scaling factor) to amplify the total measurement time.

Optionally, the method may further include the following. In the case where the terminal device determines that the measurement occasion of the first MO is the occasion outside gaps from the occasion outside gaps and the NCSG when the measurement timing window of the first MO is partially overlapping with the NCSG, the terminal device determines a first specific scaling factor for the first MO according to a period of the measurement timing window of the first MO and a period of the NCSG.

For example, the first specific scaling factor Kₚ=1/(1-(T_{SMTC}/T_{NCSG})), where T_{SMTC} represents the period of the measurement timing window of the first MO, and T_{NCSG} represents the period of the NCSG (a value of T_{NCSG} is equal to a VIRP).

Optionally, the method may further include the following. In the case where the terminal device determines that the measurement occasion of the first MO is the occasion outside gaps from the occasion outside gaps and the MG when the measurement timing window of the first MO is partially overlapping with the MG, the terminal device determines the first specific scaling factor for the first MO according to the period of the measurement timing window of the first MO and an MGRP.

For example, the first specific scaling factor Kₚ=1/(1-(T_{SMTC}/MGRP)), where T_{SMTC} represents the period of the measurement timing window of the first MO, and MGRP represents a period of the MG.

Optionally, the method may further include the following. In the case where the terminal device determines that the measurement occasion of the first MO is the occasion outside gaps from the occasion outside gaps, the NCSG, and the MG when the measurement timing window of the first MO is partially overlapping with the MG and is partially overlapping with the NCSG, the terminal device determines the first specific scaling factor for the first MO according to the period of the measurement timing window of the first MO, the MGRP, and the period of the NCSG.

Exemplarily, the first specific scaling factor

$${K}_{p} = \frac{1}{1 - \frac{{T}_{SMTC}}{MGRP} - \frac{{T}_{SMTC}}{{T}_{NCSG}}}$$

in the case where the measurement timing window of the first MO is partially within the MG and partially within the NCSG, the MG is non-overlapping with the NCSG, the period of the NCSG is different from the MGRP, and both the period of the NCSG and the MGRP are greater than the period of the measurement timing window of the first MO. Alternatively, the first specific scaling factor

$${K}_{p} = \frac{1}{1 - \frac{{T}_{SMTC}}{MGRP} - \frac{{T}_{SMTC}}{{T}_{NCSG}}} ,$$

in the case where the measurement timing window of the first MO is partially within the MG and partially within the NCSG, the MG is non-overlapping with the NCSG, the period of the NCSG is the same as the MGRP, and the period of the measurement timing window of the first MO is less than half of the period of the NCSG/the MGRP. T_{NCSG} represents the period of the NCSG, and T_{SMTC} represents the period of the measurement timing window of the first MO.

Exemplarily, the first specific scaling factor

$${K}_{p} = \frac{1}{1 - \frac{{T}_{SMTC}}{min ( {T}_{NCSG} , MGRP )}}$$

in the case where

the measurement timing window of the first MO is partially within the MG and partially within the NCSG, and the MG is at least partially overlapping with the NCSG, that is, the MG is partially overlapping or fully overlapping with the NCSG. T_{NCSG} represents the period of the NCSG, and T_{SMTC} represents the period of the measurement timing window of the first MO.

As described in the related art, to calculate the measurement period of the first MO, the terminal device needs to select a CSSF according to the actual measurement occasion and calculates the measurement period according to the CSSF. For example, CSSF_{outside_gap} is used in the case where the measurement is to be conducted outside the MG, and CSSF_{within_gap} is used in the case where the measurement is to be conducted within the MG.

In some embodiments of the disclosure, for example, in the case where the communication system allows measurement to be conducted within the NCSG and outside gaps, or in the case where the communication system allows measurement to be conducted within the MG, within the NCSG, and outside gaps but the network device configures that the terminal device can conduct measurement only within the NCSG and outside gaps, the terminal device performs processing on case 1 and/or case 2, where a CSSF for the first MO is a CSSF corresponding to the MG or a CSSF corresponding to the NCSG in the case where the measurement occasion of the first MO is the NCSG.

That is to say, the CSSF corresponding to the NCSG, e.g., CSSF_{within_ncsg}, may be introduced. For the MO to be measured within the NCSG, the measurement period of the MO is calculated with CSSF_{within_ncsg}. Alternatively, CSSF_{within_gap} can be still used, and for the MO to be measured within the NCSG, the measurement period of the MO can be calculated with CSSF_{within_gap}.

In other embodiments of the disclosure, for example, in the case where the communication system allows measurement to be conducted within the NCSG and within the MG, or in the case where the communication system allows measurement to be conducted within the MG, within the NCSG, and outside gaps, the terminal device performs processing on at least one of cases 3 to 7, where the CSSF for the first MO is the CSSF corresponding to the NCSG in the case where the measurement occasion of the first MO is the NCSG, and the CSSF for the first MO is the CSSF corresponding to the MG in the case where the measurement occasion of the first MO is the MG.

That is to say, the CSSF corresponding to the NCSG, e.g., CSSF_{within_ncsg}, may be introduced. Measurement to be conducted within the NCSG corresponds to a CSSF and measurement to be conducted within the MG corresponds to a different CSSF.

Optionally, the CSSF for the NCSG is determined according to at least one of: number of PCCs to be measured within the NCSG, number of SCCs to be measured within the NCSG, number of inter-frequency MOs to be measured within the NCSG, number of intra-frequency MOs to be measured within the NCSG, an NCSG sharing factor for the inter-frequency MOs and an NCSG sharing factor for the intra-frequency MOs, or an operation scenario of the terminal device.

Exemplarily, similar to the calculation of CSSF_{outside_gap,i} in the related art (III), the CSSF for the NCSG is determined according to at least one of the number of PCCs to be measured within the NCSG, the number of SCCs to be measured within the NCSG, or the number of inter-frequency MOs to be measured within the NCSG. For example, a CSSF for the PCCs is determined according to the number of PCCs, and a CSSF for the SCCs is determined according to the number of SCCs and the number of inter-frequency MOs.

Exemplarily, similar to the calculation of CSSF_{within_gap,i} in the related art (III), the CSSF for the NCSG is determined according to at least one of the number of inter-frequency MOs to be measured within the NCSG, the number of intra-frequency MOs to be measured within the NCSG, or the NCSG sharing factor for the inter-frequency MOs and the NCSG sharing factor for the intra-frequency MOs. The NCSG sharing factor for the inter-frequency MOs and the NCSG sharing factor for the intra-frequency MOs may be configured according to the network signaling, e.g., measNcsgSharingScheme.

Exemplarily, the calculation of the CSSF is further related to the operation scenario of the terminal device. The operation scenario is, for example, EN-DC, SA, NR-DC, NR eNB dual connection (NE-DC), etc. In different operation scenarios, the CSSF is calculated in different manners.

Specific application examples will be provided below by taking an SSB as an example of the first MO, to further illustrate how to determine the measurement occasion of the MO and how to calculate the CSSF in embodiments of the disclosure.

### Application Example 1

In the application example, the communication system allows the measurement of the MO to be conducted outside gaps and within the NCSG.

Exemplarily, the NCSG may be considered as a special MG. It may be considered that the NCSG is not needed and the measurement can be conducted outside gaps in response to the first condition being met. It may be considered that the NCSG is needed in response to the first condition being not met.

In the application example, the UE has the NCSG capability by default, and/or the network indicates that measurement can be conducted within the NCSG and may configure information such as a length and a period of the NCSG.

Firstly, whether the NCSG is needed for the measurement of the MO is determined according to the first condition, for example, according to information such as a frequency of the MO, a bandwidth of the MO, and an SCS of the MO, the capability of the UE, a network configuration, etc.

Case A: an overlapping situation between a measurement timing window of an MO, such as an SMTC, and an NCSG occasion needs to be further determined in the case where the NCSG is not needed for current measurement of the MO.

1. In the case where the SMTC is fully non-overlapping with the NCSG, the measurement is to be conducted outside gaps (i.e., both the MG and the NCSG are not needed), and a CSSF used for period calculation is CSSF_{outside_gap}.

2. In the case where the SMTC is fully overlapping with the NCSG, the measurement is to be conducted within the NCSG, i.e., the measurement is regarded to be conducted within the gap, and CSSF_{within_gap} or CSSF_{within_ncsg} is used for period calculation.

3. In the case where the SMTC is partially overlapping with the NCSG, the UE can select to conduct the measurement only within the NCSG or outside gaps according to different situations. CSSF_{outside_gap} is used for period calculation in the case where the measurement is to be conducted outside gaps. CSSF_{within_gap} or CSSF_{within_ncsg} is used for period calculation in the case where the measurement is to be conducted within the NCSG.

(1) Scaling factor Kₚ for period calculation needs to be adjusted to Kₚ=1/(1-(T_{SMTC}/T_{NCSG})) in the case where the measurement is allowed to be conducted outside gaps, where T_{NCSG} represents a repetition period of the NCSG. A condition for allowing the measurement to be conducted outside gaps may be a condition in an existing protocol, for example, a condition that the MO is an intra-frequency SSB with no gap; or a condition that the MO is an inter-frequency SSB with no gap, the UE has the CA capability, and both the UE capability and the network signaling support the measurement with no-gap.

(2) In the case where the measurement is allowed to be conducted within the NCSG, Kₚ is not needed for calculating the measurement period, or Kₚ is set to 1 for calculating the measurement period. A condition for allowing the measurement to be conducted within the NCSG may be that the MO is an inter-frequency SSB with no gap, the UE has no CA capability, and both the UE capability and the network signaling support measurement within the NCSG. New UE capability and new network signaling may be introduced for the measurement conducted within the NCSG, and a new determination condition may be introduced to determine an MO measurement of which can be conducted within the NCSG and needs no MG, but it cannot be achieved that there may be no interruption for the measurement.

Case B: the NCSG is needed for measurement of an MO, and the UE can measure the MO only within the NCSG. In this case, the following may be included. 1. CSSF_{within_gap} or CSSF_{within_ncsg} is used for period calculation. 2. Likewise, the UE capability, the network signaling, etc. may be involved, and the measurement can be conducted within the NCSG in the case where all the UE capability, the network signaling, etc. satisfy requirements.

### Application Example 2

In the application example, the communication system allows the measurement of the MO to be conducted within the MG and within the NCSG. The UE is allowed to measure the MO within the MG and within the NCSG and is configured with information such as a length and a period of the NCSG and a length and a period of the MG.

Exemplarily, the NCSG may be configured as a special no-gap. That is, it may be considered that the MG is not needed but only the NCSG is needed in the case where the first condition is met, and that the MG is needed in the case the first condition is not met.

In the example, a CSSF for the NCSG (CSSF_{within_ncsg}) and a CSSF for the MG (CSSF_{within_gap}) can be calculated separately. Equivalently, no-gap in the related art (I) is replaced with the NCSG, and MOs that can be measured completely outside gaps referred before now all are to be measured within the NCSG. First, whether the MG is needed for the MO is determined, i.e., whether the MO can be measured within the NCSG is determined.

Case A: in the case where the first condition is met and the measurement can be conducted in the NCSG, an overlapping situation between the measurement timing window of the MO (for example, an SMTC of an SSB) and the NCSG occasion/an MG occasion needs to be further determined. As illustrated in the following table, 9 cases (cases a to i) may be included in total.

TABLE 7
overlapping situations between SMTC and NCSG/MG
(measurement can be conducted within NCSG)

| | Fully | Partially | | Fully non- |
|---|---|---|---|---|
| | overlapping | overlapping | | overlapping |
| SMTC | with NCSG | with NCSG | | with NCSG |
| Fully | a. MG or NCSG. | b. MG or NCSG. | | c. MG |
| overlapping | Depending on a priority of | Depending on a priority of | | |
| with MG | the NCSG and a priority of | the NCSG and a priority of | | |
| | the MG, to ensure at most | the MG, to ensure at most one | | |
| | one active gap type per | active gap type per SMTC | | |
| | SMTC occasion. | occasion. | | |
| Partially | d. MG or NCSG. | e. MG or NCSG. | | f. MG |
| overlapping | Depending on a priority of | Depending on a priority of | | |
| with MG | the NCSG and a priority of | the NCSG and a priority of | | |
| | the MG, to ensure at most | the MG, to ensure at most one | | |
| | one active gap type per | active gap type per SMTC | | |
| | SMTC occasion. | occasion. | | |
| | | There are multiple | | |
| | | possibilities: | | |
| | | \textcircled{1} | MG and NCSG have no | |
| | | | overlapping, | |
| | | | MG + NCSG < SMTC: may | |
| | | | be MG/NCSG/no-gap; | |
| | | \textcircled{2} | MG and NCSG have no | |
| | | | overlapping, | |
| | | | MG + NCSG = SMTC: only | |
| | | | select one from MG and | |
| | | | NCSG. | |
| Fully non- | g. NCSG | h. | NCSG | i. N/A |
| overlapping | | | | |
| with MG | | | | |

The priority may be configured by a network or preset, for example, a priority of a first MG (MG1) is higher than a priority of the NCSG, and the priority of the NCSG is higher than a priority of a second MG (MG2).

The following scenario configurations may be included in the communication system. 1. In the case where the SMTC is fully overlapping with the NCSG and is fully non-overlapping with the MG (corresponding to case g), or the SMTC is partially overlapping with the NCSG and is fully non-overlapping with the MG (corresponding to case h), the measurement is to be conducted within the NCSG.

2. In the case where the SMTC is fully non-overlapping with the NCSG and is fully overlapping with the MG (corresponding to case c), or the SMTC is fully non-overlapping with the NCSG and is partially overlapping with the MG (corresponding to case f), the measurement is to be conducted within the MG.

3. In the case where part of the SMTC is partially overlapping with the NCSG, and another part of the SMTC is partially overlapping with the MG (corresponding to case e), the MO can be measured only within the MG (no measurement is conducted at SMTC occasions not overlapping with the MG), or the MO can be measured only within the NCSG (no measurement is conducted at SMTC occasions not overlapping with the NCSG), or it can be selected to measure the MO in the NCSG or the MG according to a configuration of the MO, and the UE capability or network signaling, and a CSSF and a measurement period are calculated according to the NC SG selected for use or the MG selected for use.

For example, in the case where the UE has the CA capability and both the UE and the network signaling support measurement within the NCSG, inter-frequency measurement of the MO is to be conducted within the NCSG; otherwise inter-frequency measurement of the MO is to be conducted within the MG.

In addition to the foregoing scenarios, in the case where other scenarios occur, determination may be made according to table 7. Generally, the other scenarios may be considered as an unreasonable configuration. Specifically, in the example, in the case where multiple MGs overlap at a time-domain position, only one MG at the overlapping position can be used eventually, in other words, only one MG may be active. The actually used/active MG may be determined according to priorities of MGs/sharing ratios of MGs, etc., and thus in table 7 scenarios a/b/d may be absent. In scenario e, there is no overlapping between the NCSG and the MG.

Case B: in the case where the first condition is not met, the MG is needed for measurement, and measurement can be conducted only within the MG.

In this case, a CSSF for the NC SG and a CSSF for the MG can be calculated separately, and an MO corresponds to an NC SG or an MG. The network can provide configurations to ensure that each MO can be measured only within a corresponding MG or a corresponding NCSG, and for CSSF calculation, only an MO that can be measured is considered.

### Application Example 3

In the application example, the communication system allows the measurement of the MO to be conducted within the MG, within the NCSG, and outside gaps.

Furthermore, the actual measurement occasion and the scaling factor may be determined in a manner similar to that in application example 1 in the case where the network configures that the terminal device is allowed to conduct measurement only within the NCSG and outside the NCSG. The actual measurement occasion and the scaling factor may be determined in a manner similar to that in application example 2 in the case where the network configures that the terminal device is allowed to conduct measurement only within the NCSG and within the MG.

First, whether the MG and/or the NC SG are needed for the measurement of the MO needs to be determined in any one of the following.

Similar to application example 1, the NCSG is regarded as a special MG. Whether the MG and/or the NCSG are needed for the measurement of the MO is determined according to the first condition. It is determined that no-gap is needed for the measurement of the MO in the case where the first condition is met, and the MG or the NCSG is needed for the measurement in the case where the first condition is not met.

Similar to application example 2, the NCSG is regarded as a special no-gap. Whether the MG and/or the NCSG are needed for the measurement of the MO is determined according to the first condition. It is determined that no-gap or the NCSG is needed for the measurement of the MO in the case where the first condition is met, and the MG is needed for the measurement in the case where the first condition is not met.

The NSCG is independent from the no-gap and the MG. A CSSF for the NSCG, a CSSF for the MG, and a CSSF for the no-gap can be calculated separately. First, whether the MG is needed is determined according to the first condition. Measurement of the MO is classified according to the second condition or the third condition.

Specifically, a determination result includes the following.

Case A: an overlapping situation between the SMTC and the MG/NCSG is further determined in the case where no MG/NCSG (complete no-gap) is needed for the MO. Specifically, the following cases in table 8 are included.

TABLE 8
overlapping situation between SMTC and NCSG/MG (no MG/NCSG is needed)

| | Fully | Partially | | Fully non- |
|---|---|---|---|---|
| | overlapping | overlapping | | overlapping |
| SMTC | with NCSG | with NCSG | | with NCSG |
| Fully | MG | (MG includes NCSG) | | MG |
| overlapping | | MG or NCSG | | |
| with MG | | | | |
| Partially | (NCSG includes MG) | Measurement conducted | | Intra-frequency |
| overlapping | NCSG | within MG, within NCSG, | | measurement conducted |
| with MG | | or at the outside-gap; | | at the outside-gap, and |
| | | classified into: | | inter-frequency |
| | | 1, | MG and NCSG have | measurement depending |
| | | | no overlapping, | on the UE capability |
| | | | MG + NCSG < SMTC | |
| | | 2, | MG and NCSG have | |
| | | | no overlapping, | |
| | | | MG + NCSG = SMTC | |
| Fully non- | NCSG | NCSG/outside gap | | Measurement conducted |
| overlapping | | | | outside gaps |
| with MG | | | | |

As illustrated in table 8, the following is included.

1. In the case where the SMTC is fully non-overlapping with the NCSG, i.e., the NCSG is independent of the SMTC, the following can be implemented in conjunction with related art (I).

1.1. In the case where the SMTC is fully non-overlapping with the MG, the measurement is to be conducted outside gaps.

1.2. In the case where the SMTC is partially overlapping with the MG, the measurement occasion is selected from the MG and the occasion outside gaps, and specifically, whether the MG or the occasion outside gaps is used may be determined according to the MO configuration, the UE capability, etc. Kₚ=1/(1-(T_{SMTC}/MGRP)) in the case where the measurement is to be conducted outside gaps.

1.3. In the case where the SMTC is fully non-overlapping with the NCSG and is fully overlapping with the MG, the measurement is to be conducted within the MG.

2. In the case where the SMTC is fully non-overlapping with the MG, i.e., the MG is independent of the SMTC, the following can be implemented in a manner similar to that in application example 1.

2.1. Similar to case at 1.1, in the case where the SMTC is fully non-overlapping with the NCSG, the measurement is to be conducted outside gaps.

2.2. In the case where the SMTC is fully overlapping with the NCSG, the measurement is to be conducted within the NCSG.

2.3. In the case where the SMTC is partially overlapping with the NCSG, whether the NCSG or the occasion outside gaps is selected for use is determined according to the MO configuration and the UE capability. For example, in the case where the inter-frequency measurement is to be conducted and the UE has no CA capability, the inter-frequency measurement is to be conducted within the NCSG. In the case where the intra-frequency measurement or the inter-frequency measurement is to be conducted and the UE has the CA capability, the intra-frequency measurement or the inter-frequency measurement is to be conducted outside gaps. In this case, Kₚ needs to be modified to Kₚ=1/(1-(T_{SMTC}/T_{NCSG})).

3. Assuming that the SMTC may have a first part that is overlapping with the NCSG, a second part that is partially overlapping with the MG, and a third part (i.e., a first time range) that is non-overlapping with both the NCSG and the MG, the following can be included.

3.1. In the case where the third part of the SMTC exists, NCSG/MG/no-gap can be adopted for the measurement.

The CSSF and the measurement period are calculated according to the NCSG/MG in the case where the measurement is to be conducted within the NCSG or within the MG.

Kₚ needs to be modified as follows in the case where the measurement is to be conducted outside gaps.

\textcircled{1} The first specific scaling factor

$${K}_{p} = \frac{1}{1 - \frac{{T}_{SMTC}}{MGRP} - \frac{{T}_{SMTC}}{{T}_{NCSG}}}$$

in the case where the measurement timing window of the first MO is partially within the MG and partially within the NCSG, the MG is non-overlapping with the NCSG, the period of the NCSG is different from the MGRP, and both the period of the NCSG and the MGRP are greater than the period of the measurement timing window of the first MO. Alternatively, the first specific scaling factor

$${K}_{p} = \frac{1}{1 - \frac{{T}_{SMTC}}{MGRP} - \frac{{T}_{SMTC}}{{T}_{NCSG}}}$$

in the case where the measurement timing window of the first MO is partially within the MG and partially within the NCSG, the MG is non-overlapping with the NCSG, the period of the NCSG is the same as the MGRP, and the period of the measurement timing window of the first MO is less than half of the period of the NCSG/the MGRP. T_{NCSG} represents the period of the NCSG, and T_{SMTC} represents the period of the measurement timing window of the first MO.

\textcircled{2} The first specific scaling factor

$${K}_{p} = \frac{1}{1 - \frac{{T}_{SMTC}}{min ( {T}_{NCSG} , MGRP )}}$$

in the case where the measurement timing window of the first MO is partially within the MG and partially within the NCSG, and the MG is at least partially overlapping with the NCSG, that is, the MG is partially overlapping or fully overlapping with the NCSG. T_{NCSG} represents the period of the NCSG, and T_{SMTC} represents the period of the measurement timing window of the first MO.

3.2. In the case where the third part of the SMTC is absent, the measurement is to be conducted within the NCSG or within the MG, and the CSSF and the measurement period are calculated according to the NCSG/MG.

Case B: in the case where the MG is not needed for measurement of the MO and the NCSG is needed for measurement of the MO, the measurement occasion is determined from the NCSG and the MG according to the overlapping situation between the SMTC window and the NCSG/MG, which is similar to case A in application example 2.

Case C: in the case where the MG is needed for the MO, the measurement is to be conducted within the MG.

In the application example, a CSSF for the NCSG and a CSSF for the MG may be calculated separately, and an MO corresponds to an NCSG or an MG. The network can ensure that each MO can be measured only within a corresponding MG or a corresponding NCSG, and for CSSF calculation, only an MO that can be measured is considered.

### Application Example 4

A manner of calculating the CSSF for the NCSG (hereinafter CSSF_{within_ncsg} for short) is provided in the application example. Specifically, CSSF_{within_ncsg} is calculated according to the number of serving carriers.

CSSF_{within_ncsg} is related to the number of serving carriers and the number of inter-frequency measurement MOs. The serving carrier herein refers to a PCC/SCC configured with SSB/CSI-RS measurement that needs to be conducted within the NCSG. The inter-frequency measurement MOs refer to MOs measurement of which can be conducted within the NCSG.

Specifically, a possible calculation manner of CSSF_{within_ncsg} in an SA scenario is illustrated in table 9.

TABLE 9
CSSF_{within}_ncsg, i for UE for SA mode

| | | | | CSSF_{NCSG, i, i} for FR2 |
|---|---|---|---|---|
| | CSSF_{NCSG, i} | CSSF_{NCSG, i} | CSSF_{NCSG, i} | SCC where neighbour cell |
| Scenario | for FR1 PCC | for FR1 SCC | for FR2 PCC | measurement is required |
| FR1 only CA | 1 + N_{PCC}_CSIRS | N_{SCC}_SSB + Y + | N/A | N/A |
| | or N_{PCC}_CSIRS | 2 × N_{SCC}_CSIRS | | |
| FR2 only | N/A | N/A | 1 + N_{PCC}_CSIRS | N/A |
| intra band CA | | | Or N_{PCC}_CSIRS | |
| FR2 only | N/A | N/A | 1 | 2*(1 + |
| inter band CA | | | | N_{SCC}_CSIRS_FR2_NCM) ^{Note 3, 5} |
| FR1 + | 1 + N_{PCC}_CSIRS | 2 × (N_{SCC}_SSB + | N/A | 2 × (1 + |
| FR2 CA (FR1 | Or N_{PCC}_CSIRS | Y + 2* N_{SCC}_CSIRS − | | N_{SCC}_CSIRS_FR2_NCM) ^{Note 3, 5} |
| PCell) ^{Note 1} | | 1 − N_{SCC}_CSIRS_FR2_NCM) | | |

| | CSSF_{NCSG, i} for FR2 | CSSF_{NCSG, i} |
|---|---|---|
| | SCC where neighbour cell | for inter-frequency |
| Scenario | measurement is not required | MO within NCSG |
| FR1 only CA | N/A | N_{SCC}_SSB + Y + |
| | | 2 × N_{SCC}_CSIRS |
| FR2 only | N_{SCC}_SSB + Y + | N_{SCC}_SSB + Y + |
| intra band CA | 2 × N_{SCC}_CSIRS | 2 × N_{SCC}_CSIRS |
| FR2 only | 2 × (N_{SCC}_SSB + Y + | 2 × (N_{SCC}_SSB + |
| inter band CA | 2 × N_{SCC}_CSIRS − 1 − | Y + 2 × |
| | N_{SCC}_CSIRS_FR2_NCM) | N_{SCC}_CSIRS − 1 − |
| | | N_{SCC}_CSIRS_FR2_NCM) |
| FR1 + | 2 × (_{NSCC}_SSB + Y + | 2 × (N_{SCC}_SSB + Y + |
| FR2 CA (FR1 | 2 × N_{SCC}_CSIRS − 1 − | 2 × N_{SCC}_CSIRS − |
| PCell) ^{Note 1} | N_{SCC}_CSIRS_FR2_NCM) | 1 − N_{SCC}_CSIRS_FR2_NCM) |

^{Note 1}:
Only one FRI operating band and one FR2 operating band are included for FR1 + FR2 inter-band CA.
Note 2:
Selection of FR2 SCC where neighbour cell measurement is required follows a related protocol.
^{Note 3}:
CSSF_{outside}_gap,i =1 if only one cell is configured and no inter-frequency MO within NCSG.
Note 4:
Y is the number of configured inter-frequency MOs without MG that are being measured within NCSG; otherwise, it is 0.
^{Note 5}:
Only two NR FR2 operating bands are included for FR2 inter-band CA.
Note 6:
N_{PCC}_CSIRS = 1 if PCC is with either both SSB and CSI-RS based L3 measurement configured or only CSI-RS based L3 measurement configured; otherwise, N_{PCC}_CSIRS = 0.
Note 7:
N_{SCC}_CSIRS = Number of configured cell(s) with either both SSB and CSI-RS based L3 measurement configured or only CSI-RS based L3 measurement configured
Note 8:
N_{SCC}_CSIRS_FR2_NCM = 1 if FR2 SCC, where neighbour cell measurement is required, is with either both SSB and CSI-RS configured or only CSI-RS measurement configured; otherwise, N_{SCC}_CSIRS_FR2_NCM = 0.
Note 9:
N_{SCC}_SSB = Number of configured SCell(s) with only SSB based L3 measurement configured

The following can be seen from table 9.

1. A value of CSSF_{within_ncsg} for intra-frequency measurement on the PCC is related to N_{PCC_CSIRS}, and a value of N_{PCC_CSIRS} depends on whether the PCC is configured with CSI-RS based L3 measurement.

2. A value of CSSF_{within_ncsg} for intra-frequency measurement on the SCC is related to parameters such as N_{SCC_SSB}, N_{SCC_CSIRS}, and Y. N_{SCC_SSB} represents the number of configured SCCs with only SSB based L3 measurement configured. N_{SCC_CSIRS} represents the number of configured SCCs with either only CSI-RS based L3 measurement configured or both SSB and CSI-RS based L3 measurement configured. Y represents the number of configured inter-frequency MOs that are being measured within the NCSG (some conditions may need to be met, for example, the UE has a corresponding capability, reference signals of the inter-frequency MOs satisfy conditions such as a specific bandwidth and a specific SCS, and a time-domain position (an SMTC or a CSI-RS resource) is fully or partially overlapping with the NCSG occasion).

### Application Example 5

In the application example, CSSF_{within_ncsg} is calculated according to the number of MOs to be measured within the NCSG.

CSSF_{within_ncsg} is related to the number of MOs to be measured within the NCSG. The number of MOs to-be-measured includes: the number of intra-frequency MOs, M_{intra,i,j}, the number of inter-frequency MOs, M_{inter,i,j}, the number of all MOs, M_{tot,i,j}, and the total number of NR PRS measurements.

1. In the case that a sharing ratio configured for the intra-frequency MOs to be measured within the NCSG is the same as a sharing ratio configured for the inter-frequency MOs to be measured within the NCSG, that is, the MG is equal sharing, CSSF_{within_ncsg,i} for MO i satisfies: CSSF_{within_ncsg,i}=max(ceil(Rᵢ×M_{tot,i,j})), where j=0 . . . (160/MGRP)-1.

2. In the case where the sharing ratio configured for the intra-frequency MOs to be measure within the NCSG is different from the sharing ratio configured for the inter-frequency MOs to be measured within the NCSG, that is, the MG is not equal sharing, an intra-frequency ratio is Kᵢₙₜᵣₐ, and an inter-frequency ratio is Kᵢₙₜₑᵣ, and the following can be included. In the case where MO i is an intra-frequency MO, CSSF_{within_ncsg,i} is the maximum of: ceil(Rᵢ×Kᵢₙₜᵣₐ×M_{intra,i,j}), where M_{inter,i,j}≠0, j=0, 1 . . . , ((160/MGRP)-1); or ceil(Rᵢ×M_{intra,i,j}), where M_{inter,i,j}=0, j=0 . . . (160/MGRP)-1.

In the case where MO i is an inter-frequency MO, CSSF_{within_ncsg,i} is the maximum of: ceil(Rᵢ×Kᵢₙₜₑᵣ×M_{inter,i,j}), where M_{intra,i,j}≠0, j=0 . . . (160/MGRP)-1; or ceil(Rᵢ×M_{inter,i,j}), where M_{intra,i,j}=0, j=0 (160/MGRP)-1.

The foregoing describes specific settings and implementation manners of the embodiments of the disclosure from different perspectives by means of multiple embodiments. With the at least one embodiment, the terminal device can determine the measurement occasion of the first MO from the at least one measurement occasion that includes the NCSG according to whether the MG and/or the NCSG are needed for the measurement of the first MO. In this way, the terminal device may select to conduct the measurement of the first MO within the NCSG in the case where the measurement requirements are met, thereby reducing the data interruption time in the communication process.

Corresponding to the processing manners of at least one mentioned embodiment, a terminal device 100 is further provided in embodiments of the disclosure. As illustrated in FIG. 5, the terminal device 100 includes an occasion determination module 110. The occasion determination module 110 is configured to determine a measurement occasion of a first MO in at least one measurement occasion according to whether an MG and/or an NCSG are needed for measurement of the first MO. The at least one measurement occasion includes the NCSG.

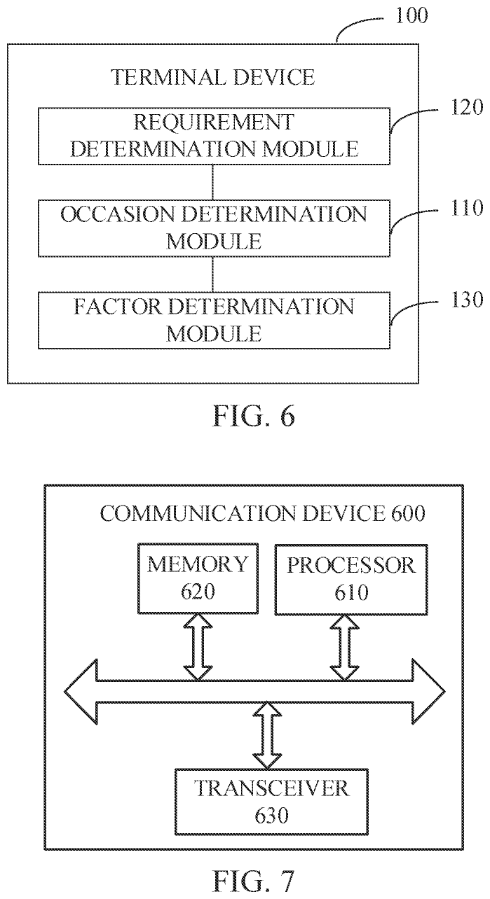

Optionally, in embodiments of the disclosure, as illustrated in FIG. 6, the terminal device may further include a requirement determination module 120. The requirement determination module 120 is configured to perform at least one of: determining, according to a first condition, whether the MG is needed for the measurement of the first MO; determining, according to the first condition, whether the NC SG is needed for the measurement of the first MO; determining, according to the first condition, whether the MG is needed for the measurement of the first MO, and determining, according to a second condition, whether the NCSG is needed for the measurement of the first MO in response to the MG being not needed for the measurement of the first MO; or determining, according to the first condition, whether the MG is needed for the measurement of the first MO, and determining, according to a third condition, whether the NCSG is needed for the measurement of the first MO in response to the MG being not needed for the measurement of the first MO.

Optionally, the first condition includes at least one of: the terminal device supporting conducting the measurement of the first MO outside the MG, the first MO being contained in an active BWP, or an active downlink BWP being an initial BWP.

Optionally, the second condition includes the first MO being contained in an active BWP.

Optionally, the third condition includes the terminal device supporting conducting measurement within the NCSG, and the first MO and an active BWP being located in a same band.

Optionally, in embodiments of the disclosure, the occasion determination module 110 is specifically configured to: determine the measurement occasion of the first MO from the NCSG and outside-gap according to a position relationship between a measurement timing window of the first MO and the NCSG, in response to the NCSG being not needed for the measurement of the first MO; and/or determine that the measurement occasion of the first MO is the NCSG, in response to the NCSG being needed for the measurement of the first MO.

Optionally, in embodiments of the disclosure, the occasion determination module 110 is specifically configured to: determine the measurement occasion of the first MO from the NCSG and the MG according to a position relationship among a measurement timing window of the first MO, the NCSG, and the MG, in response to the MG being not needed for the measurement of the first MO; and/or determine that the measurement occasion of the first MO is the MG, in response to the MG being needed for the measurement of the first MO.

Optionally, in embodiments of the disclosure, the occasion determination module 110 is specifically configured to: determine the measurement occasion of the first MO from the NCSG, the MG, and outside-gap according to a position relationship among a measurement timing window of the first MO, the NCSG, and the MG, in response to both the MG and the NCSG being not needed for the measurement of the first MO; and/or determine the measurement occasion of the first MO from the NC SG and the MG according to the position relationship among the measurement timing window of the first MO, the NCSG, and the MG, in response to the MG being not needed for the measurement of the first MO and the NCSG being needed for the measurement of the first MO; and/or determine that the measurement occasion of the first MO is the MG, in response to the MG being needed for the measurement of the first MO.

Optionally, in embodiments of the disclosure, the occasion determination module 110 is specifically configured to: determine the measurement occasion of the first MO from the MG and the outside-gap according to the position relationship between the measurement timing window of the first MO and the MG, in response to both the MG and the NCSG being not needed for the measurement of the first MO and the measurement timing window of the first MO being fully non-overlapping with the NCSG; and/or determine the measurement occasion of the first MO from the NC SG and the outside-gap according to the position relationship between the measurement timing window of the first MO and the NCSG, in response to both the MG and the NCSG being not needed for the measurement of the first MO and the measurement timing window of the first MO being fully non-overlapping with the MG; and/or determine the measurement occasion of the first MO from the NCSG, the MG, and the outside-gap according to whether the measurement timing window of the first MO contains a first time range, in response to both the MG and the NC SG being not needed for the measurement of the first MO and the measurement timing window of the first MO being partially overlapping with the MG and being partially overlapping with the NCSG, where the first time range is non-overlapping with both the MG and the NCSG.

Optionally, in embodiments of the disclosure, the occasion determination module 110 is specifically configured to: determine the measurement occasion of the first MO from the NCSG, the MG, and the outside-gap, in response to the measurement timing window of the first MO being partially overlapping with the MG and being partially overlapping with the NCSG and the measurement timing window of the first MO containing the first time range; and/or determine the measurement occasion of the first MO from the NCSG and the MG, in response to the measurement timing window of the first MO being partially overlapping with the MG and being partially overlapping with the NC SG and the measurement timing window of the first MO not containing the first time range.

Optionally, in embodiments of the disclosure, the measurement occasion of the first MO is determined from the NC SG and the MG according to the position relationship among the measurement timing window of the first MO, the NCSG, and the MG as follows. Determine that the measurement occasion of the first MO is the NCSG, in response to the measurement timing window of the first MO being at least partially overlapping with the NC SG and being fully non-overlapping with the MG; and/or determine that the measurement occasion of the first MO is the MG, in response to the measurement timing window of the first MO being fully non-overlapping with the NC SG and being at least partially overlapping with the MG; and/or determine the measurement occasion of the first MO from the NCSG and the MG according to at least one of a frequency type of the first MO, a capability of the terminal device, or network signaling, in response to the measurement timing window of the first MO being partially overlapping with the NCSG and being partially overlapping with the MG.

Optionally, in embodiments of the disclosure, the measurement occasion of the first MO is determined from the NC SG and the outside-gap according to the position relationship between the measurement timing window of the first MO and the NCSG as follows. Determine that the measurement occasion of the first MO is the outside-gap, in response to the measurement timing window of the first MO being fully non-overlapping with the NCSG; and/or determine that the measurement occasion of the first MO is the NCSG, in response to the measurement timing window of the first MO being fully overlapping with the NCSG; and/or determine the measurement occasion of the first MO from the NCSG and the outside-gap according to at least one of a frequency type of the first MO, a capability of the terminal device, or network signaling, in response to the measurement timing window of the first MO being partially overlapping with the NCSG.

Optionally, as illustrated in FIG. 6, in embodiments of the disclosure, the terminal device may further include a factor determination module 130. The factor determination module 130 is configured to: determine a first specific scaling factor for the first MO according to a period of the measurement timing window of the first MO and a period of the NCSG in response to that the terminal device determines from the NCSG and outside-gap that the measurement occasion of the first MO is the outside-gap when the measurement timing window of the first MO is partially overlapping with the NCSG; and/or determine the first specific scaling factor for the first MO according to the period of the measurement timing window of the first MO and a measurement gap repetition period (MGRP) in response to that the terminal device determines from the MG and the outside-gap that the measurement occasion of the first MO is the outside-gap when the measurement timing window of the first MO is partially overlapping with the MG; and/or determine the first specific scaling factor for the first MO according to the period of the measurement timing window of the first MO, the MGRP, and the period of the NCSG, in response to that the terminal device determines from the NCSG, the MG, and the outside-gap that the measurement occasion of the first MO is the outside-gap when the measurement timing window of the first MO is partially overlapping with the MG and is partially overlapping with the NCSG.

Optionally, in embodiments of the disclosure, a CSSF for the first MO is a CSSF corresponding to the MG or a CSSF corresponding to the NCSG in the case where the measurement occasion of the first MO is the NCSG.

Optionally, in embodiments of the disclosure, a CSSF for the first MO is a CSSF corresponding to the NCSG in the case where the measurement occasion of the first MO is the NCSG; or the CSSF for the first MO is a CSSF corresponding to the MG in the case where the measurement occasion of the first MO is the MG.

Optionally, in embodiments of the disclosure, the CSSF for the NCSG is determined according to at least one of: the number of PCCs to be measured within the NCSG, the number of SCCs to be measured within the NCSG, the number of inter-frequency MOs to be measured within the NCSG, the number of intra-frequency MOs to be measured within the NCSG, an NCSG sharing factor for the inter-frequency MOs and an NCSG sharing factor for the intra-frequency MOs, or an operation scenario of the terminal device.

The terminal device 100 in embodiments of the disclosure can implement corresponding functions of the terminal device in the foregoing method embodiments. For processes, functions, embodiment manners, and beneficial effects corresponding to various modules (sub-modules, units, components, etc.) in the terminal device 100, reference can be made to the corresponding illustration in the foregoing method embodiments, which is not repeated herein. It needs to be noted that, the described functions of various modules (sub-modules, units, components, etc.) in the terminal device 100 in embodiments of the disclosure can be implemented by different modules (sub-modules, units, components, etc.) or by the same module (sub-module, unit, component, etc.). For example, the occasion determination module and the requirement determination module may be different modules or the same module, and can implement corresponding functions of the terminal device in embodiments of the disclosure. In addition, the communication module in the embodiments of the disclosure may be implemented as a transceiver of a device, and some or all of other modules may be implemented as a processor of the device.

FIG. 7 is a schematic structural diagram of a communication device 600 according to embodiments of the disclosure. The communication device 600 includes a processor 610. The processor 610 is configured to invoke and execute computer programs stored in a memory, to implement the methods in embodiments of the disclosure.

Optionally, the communication device 600 may further include a memory 620. The processor 610 is configured to invoke and execute computer programs stored in the memory 620, to implement the methods in embodiments of the disclosure.

The memory 620 may be a separated device independent of the processor 610, or may be integrated into the processor 610.

Optionally, the communication device 600 may further include a transceiver 630. The processor 610 can control the transceiver 630 to communicate with other devices. Specifically, the transceiver 630 can transmit information or data to other devices, or receive information or data transmitted by other devices.

The transceiver 630 may include a transmitter and a receiver. The transceiver 630 may further include one or more antennas.

Optionally, the communication device 600 may be the terminal device in embodiments of the disclosure. The processor 610 is configured to invoke and execute computer programs to determine a measurement occasion of a first MO in at least one measurement occasion according to whether an MG and/or an NCSG are needed for measurement of the first MO. The at least one measurement occasion includes the NC SG.

Optionally, the communication device 600 can implement the corresponding process implemented by the terminal device in each of the methods of the embodiments of the disclosure, which will not be repeated herein for the sake of simplicity.

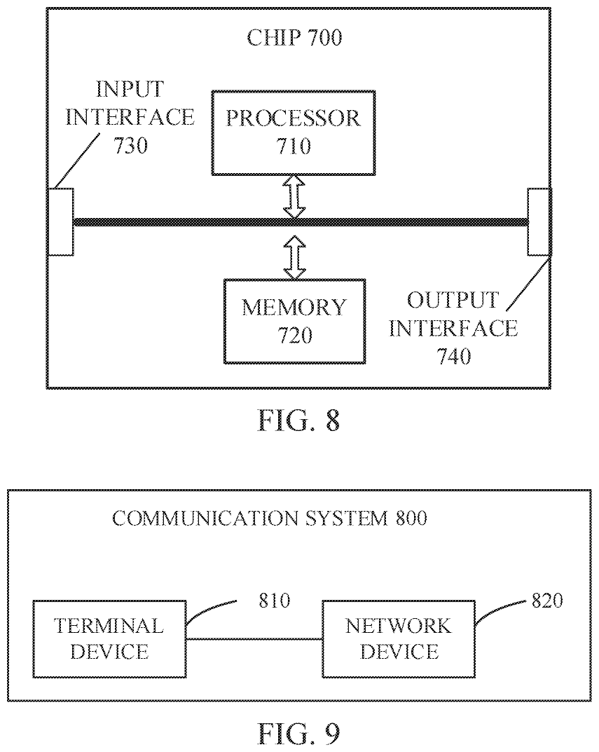

FIG. 8 is a schematic structural diagram of a chip according to embodiments of the disclosure. The chip 700 includes a processor 710. The processor 710 is configured to invoke and execute computer programs stored in a memory, to implement the methods in embodiments of the disclosure.

Optionally, the chip 700 may further include a memory 720. The processor 710 is configured to invoke and execute computer programs stored in the memory 720, to implement the methods in embodiments of the disclosure.

The memory 720 may be a separated device independent of the processor 710, or may be integrated into the processor 710.

Optionally, the chip 700 may further include an input interface 730. The processor 710 can control the input interface 730 to communicate with other devices or chips. Specifically, the input interface 730 can obtain information or data transmitted by other devices or chips.

Optionally, the chip 700 may further include an output interface 740. The processor 710 can control the output interface 740 to communicate with other devices or chips. Specifically, the output interface 740 can output information or data to other devices or chips.

Optionally, the chip may be applied to the terminal device in the embodiments of the disclosure, and the chip can implement the corresponding process implemented by the terminal device in each of the methods in the embodiments of the disclosure, which will not be repeated herein for the sake of simplicity.

It may be understood that, the chip mentioned in the embodiments of the disclosure may also be referred to as a system-level chip, a system chip, a chip system, a system-on-a-chip chip, or the like.

The above processor may be a general-purpose processor, a digital signal processor (DSP), a field programmable gate array (FPGA), an application specific integrated circuit (ASIC), or other programmable logic devices, transistor logic devices, discrete hardware components. The general purpose processor may be a microprocessor or any conventional processor or the like.

The memory may be a volatile memory or a non-volatile memory, or may include both the volatile memory and the non-volatile memory. The non-volatile memory may be a read-only memory (ROM), a programmable ROM (PROM), an erasable PROM (EPROM), an electrically EPROM (EEPROM), or a flash memory. The volatile memory may be a random access memory (RAM).

It is to be understood that, the above illustration of the memory is intended for illustration rather than limitation. For example, the memory of embodiments may also be a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), a direct rambus RAM (DR RAM), and so on. In other words, the memory of embodiments is intended to include, but is not limited to, these and any other suitable types of memory.

FIG. 9 is a schematic block diagram of a communication system 800 according to embodiments of the disclosure. The communication system 800 includes a terminal device 810 and a network device 820.

The terminal device 810 is configured to determine a measurement occasion of a first MO in at least one measurement occasion according to whether an MG and/or an NCSG are needed for measurement of the first MO. The at least one measurement occasion includes the NCSG.

The terminal device 810 can be configured to implement the corresponding functions implemented by the terminal device in the foregoing method in embodiments of the disclosure, and the network device 820 can be configured to implement the corresponding functions implemented by the network device in the foregoing method in embodiments of the disclosure, which will not be repeated herein for the sake of simplicity.

In the above embodiments, all or part of the illustrated functions can be implemented through software, hardware, firmware, or any other combination thereof. When implemented by software, all or part of the above embodiments can be implemented in the form of a computer program product. The computer program product includes one or more computer instructions. When the computer instructions are loaded and executed on a computer, all or part of the processes or functions of the embodiments of the disclosure are performed. The computer can be a general-purpose computer, a special-purpose computer, a computer network, or other programmable apparatuses. The computer instructions can be stored in a computer-readable storage medium, or transmitted from one computer-readable storage medium to another computer-readable storage medium. For example, the computer instruction can be transmitted from one website, computer, server, or data center to another website, computer, server, or data center in a wired manner or in a wireless manner. Examples of the wired manner can be a coaxial cable, an optical fiber, a digital subscriber line (DSL), etc. The wireless manner can be, for example, infrared, wireless, microwave, etc. The computer-readable storage medium can be any computer-accessible usable-medium or a data storage device such as a server, a data center, or the like which is integrated with one or more usable media. The usable medium can be a magnetic medium (such as a soft disc, a hard disc, or a magnetic tape), an optical medium (such as a digital video disc (DVD)), or a semiconductor medium (such as a solid state disk (SSD)), etc.

It should be understood that, in various embodiments of the disclosure, the magnitude of a sequence number of each process mentioned above does not mean an order of execution, and the order of execution of each process should be determined by its function and an internal logic and shall not constitute any limitation to an embodiment process of embodiments of the disclosure.

It may be evident to those skilled in the art that, for the sake of convenience and simplicity, in terms of the specific working processes of the foregoing systems, apparatuses, and units, reference can be made to the corresponding processes of the above-mentioned method embodiments, which will not be repeated herein.

The above is only a specific embodiment of the disclosure and is not intended to limit the scope of protection of the disclosure. Any modification and replacement made by those skilled in the art within the technical scope of the disclosure shall be included in the scope of protection of the disclosure. Therefore, the scope of protection of the disclosure should be stated in the scope of protection of the claims.

What is claimed is:

1. A method for measurement-occasion determination, comprising:
determining, by a terminal device, a measurement occasion of a first measurement object (MO) in at least one measurement occasion according to whether a measurement gap (MG) and/or a network control small gap (NCSG) are needed for measurement of the first MO, wherein
the at least one measurement occasion comprises the NCSG.

2. The method of claim 1, further comprising at least one of:
determining, by the terminal device according to a first condition, whether the MG is needed for the measurement of the first MO;
determining, by the terminal device according to the first condition, whether the NC SG is needed for the measurement of the first MO;
determining, by the terminal device according to the first condition, whether the MG is needed for the measurement of the first MO, and determining, by the terminal device according to a second condition, whether the NCSG is needed for the measurement of the first MO in response to the MG being not needed for the measurement of the first MO; or
determining, by the terminal device according to the first condition, whether the MG is needed for the measurement of the first MO, and determining, by the terminal device according to a third condition, whether the NCSG is needed for the measurement of the first MO in response to the MG being needed for the measurement of the first MO.

3. The method of claim 2, wherein the first condition comprises at least one of:
the terminal device supporting conducting the measurement of the first MO outside the MG;
the first MO being contained in an active bandwidth part (BWP); or
an active downlink BWP being an initial BWP.

4. The method of claim 1, wherein determining, by the terminal device, the measurement occasion of the first MO in the at least one measurement occasion according to whether the MG and/or the NCSG are needed for measurement of the first MO, comprises:
determining, by the terminal device, the measurement occasion of the first MO from the NCSG, the MG, and outside-gap according to a position relationship among a measurement timing window of the first MO, the NCSG, and the MG, in response to both the MG and the NCSG being not needed for the measurement of the first MO; and/or
determining, by the terminal device, the measurement occasion of the first MO from the NCSG and the MG according to the position relationship among the measurement timing window of the first MO, the NCSG, and the MG, in response to the MG being not needed for the measurement of the first MO and the NCSG being needed for the measurement of the first MO; and/or
determining, by the terminal device, that the measurement occasion of the first MO is the MG, in response to the MG being needed for the measurement of the first MO.

5. The method of claim 4, wherein determining, by the terminal device, the measurement occasion of the first MO from the NC SG and the MG according to the position relationship among the measurement timing window of the first MO, the NCSG, and the MG, comprises:
determining, by the terminal device, that the measurement occasion of the first MO is the NCSG, in response to the measurement timing window of the first MO being at least partially overlapping with the NC SG and being fully non-overlapping with the MG; and/or
determining, by the terminal device, that the measurement occasion of the first MO is the MG, in response to the measurement timing window of the first MO being fully non-overlapping with the NC SG and being at least partially overlapping with the MG; and/or
determining, by the terminal device, the measurement occasion of the first MO from the NCSG and the MG according to at least one of a frequency type of the first MO, a capability of the terminal device, or network signaling, in response to the measurement timing window of the first MO being partially overlapping with the NC SG and being partially overlapping with the MG.

6. The method of claim 1, wherein determining, by the terminal device, the measurement occasion of the first MO in the at least one measurement occasion according to whether the NCSG is needed for the measurement of the first MO, comprises: determining, by the terminal device, the measurement occasion of the first MO from the NC SG and outside-gap according to a position relationship between a measurement timing window of the first MO and the NCSG, in response to the NCSG being not needed for the measurement of the first MO; wherein
determining, by the terminal device, the measurement occasion of the first MO from the NCSG and the outside-gap according to the position relationship between the measurement timing window of the first MO and the NCSG, comprises:
determining, by the terminal device, that the measurement occasion of the first MO is the outside-gap, in response to the measurement timing window of the first MO being fully non-overlapping with the NCSG; and/or
determining, by the terminal device, that the measurement occasion of the first MO is the NCSG, in response to the measurement timing window of the first MO being fully overlapping with the NCSG; and/or
determining, by the terminal device, the measurement occasion of the first MO from the NCSG and the outside-gap according to at least one of a frequency type of the first MO, a capability of the terminal device, or network signaling, in response to the measurement timing window of the first MO being partially overlapping with the NCSG.

7. The method of claim 1, further comprising:
determining, by the terminal device, a first specific scaling factor for the first MO according to a period of a measurement timing window of the first MO and a period of the NCSG, in response to that the terminal device determines from both the NCSG and outside-gap that the measurement occasion of the first MO is the outside-gap when the measurement timing window of the first MO is partially overlapping with the NCSG; and/or
determining, by the terminal device, the first specific scaling factor for the first MO according to the period of the measurement timing window of the first MO and a measurement gap repetition period (MGRP), in response to that the terminal device determines from both the MG and the outside-gap that the measurement occasion of the first MO is the outside-gap when the measurement timing window of the first MO is partially overlapping with the MG; and/or
determining, by the terminal device, the first specific scaling factor for the first MO according to the period of the measurement timing window of the first MO, the MGRP, and the period of the NCSG, in response to that the terminal device determines from the NCSG, the MG, and the outside-gap that the measurement occasion of the first MO is the outside-gap when the measurement timing window of the first MO is partially overlapping with the MG and is partially overlapping with the NCSG.

8. The method of claim 1, wherein the measurement occasion of the first MO is the NCSG and a carrier specific scaling factor (CSSF) for the first MO is a CSSF corresponding to the NCSG; or the measurement occasion of the first MO is the MG and the CSSF for the first MO is a CSSF corresponding to the MG.

9. The method of claim 8, wherein the CSSF for the NCSG is determined according to at least one of:
number of primary carrier components (PCCs) to be measured within the NCSG;
number of secondary carrier components (SCCs) to be measured within the NCSG;
number of inter-frequency MOs to be measured within the NCSG;
number of intra-frequency MOs to be measured within the NCSG;
an NCSG sharing factor for the inter-frequency MOs and an NCSG sharing factor for the intra-frequency MOs; or
an operation scenario of the terminal device.

10. A terminal device, comprising:
a processor; and
a memory storing a computer program which, when executed by the processor, causes the terminal device to:
determine a measurement occasion of a first measurement object (MO) in at least one measurement occasion according to whether a measurement gap (MG) and/or a network control small gap (NCSG) are needed for measurement of the first MO, wherein
the at least one measurement occasion comprises the NCSG.

11. The terminal device of claim 10, wherein the computer program is further executed by the processor to cause the terminal device to perform at least one of:
determining, according to a first condition, whether the MG is needed for the measurement of the first MO;
determining, according to the first condition, whether the NCSG is needed for the measurement of the first MO;
determining, according to the first condition, whether the MG is needed for the measurement of the first MO, and determining, according to a second condition, whether the NCSG is needed for the measurement of the first MO in response to the MG being not needed for the measurement of the first MO; or
determining, according to the first condition, whether the MG is needed for the measurement of the first MO, and determining, according to a third condition, whether the NCSG is needed for the measurement of the first MO in response to the MG being needed for the measurement of the first MO.

12. The terminal device of claim 11, wherein the first condition comprises at least one of:
the terminal device supporting conducting the measurement of the first MO outside the MG;
the first MO being contained in an active bandwidth part (BWP); or
an active downlink BWP being an initial BWP.

13. The terminal device of claim 10, wherein the computer program executed by the processor to cause the terminal device to determine the measurement occasion of the first MO is executed by the processor to cause the terminal device to:
determine the measurement occasion of the first MO from the NCSG, the MG, and outside-gap according to a position relationship among a measurement timing window of the first MO, the NCSG, and the MG, in response to both the MG and the NCSG being not needed for the measurement of the first MO; and/or
determine the measurement occasion of the first MO from the NCSG and the MG according to the position relationship among the measurement timing window of the first MO, the NCSG, and the MG, in response to the MG being not needed for the measurement of the first MO and the NC SG being needed for the measurement of the first MO; and/or
determine that the measurement occasion of the first MO is the MG, in response to the MG being needed for the measurement of the first MO.

14. The terminal device of claim 13, wherein the computer program executed by the processor to cause the terminal device to perform determining the measurement occasion of the first MO from the NCSG and the MG according to the position relationship among the measurement timing window of the first MO, the NCSG, and the MG is executed by the processor to cause the terminal device to perform:
determining that the measurement occasion of the first MO is the NCSG, in response to the measurement timing window of the first MO being at least partially overlapping with the NCSG and being fully non-overlapping with the MG; and/or
determining that the measurement occasion of the first MO is the MG, in response to the measurement timing window of the first MO being fully non-overlapping with the NCSG and being at least partially overlapping with the MG; and/or
determining the measurement occasion of the first MO from the NC SG and the MG according to at least one of a frequency type of the first MO, a capability of the terminal device, or network signaling, in response to the measurement timing window of the first MO being partially overlapping with the NCSG and being partially overlapping with the MG.

15. The terminal device of claim 10, wherein the computer program executed by the processor to cause the terminal device to determine the measurement occasion of the first MO in the at least one measurement occasion according to whether the NCSG is needed for the measurement of the first MO is executed by the processor to cause the terminal device to determine the measurement occasion of the first MO from the NCSG and outside-gap according to a position relationship between a measurement timing window of the first MO and the NCSG, in response to the NC SG being not needed for the measurement of the first MO; wherein
the computer program executed by the processor to cause the terminal device to perform the measurement occasion of the first MO from the NCSG and the outside-gap according to the position relationship between the measurement timing window of the first MO and the NCSG is executed by the processor to cause the terminal device to perform:
determining that the measurement occasion of the first MO is the outside-gap, in response to the measurement timing window of the first MO being fully non-overlapping with the NCSG; and/or
determining that the measurement occasion of the first MO is the NCSG, in response to the measurement timing window of the first MO being fully overlapping with the NCSG; and/or
determining the measurement occasion of the first MO from the NCSG and the outside-gap according to at least one of a frequency type of the first MO, a capability of the terminal device, or network signaling, in response to the measurement timing window of the first MO being partially overlapping with the NCSG.

16. The terminal device of claim 10, wherein the computer program is further executed by the processor to cause the terminal device to:
determine a first specific scaling factor for the first MO according to a period of the measurement timing window of the first MO and a period of the NCSG, in response to that the terminal device determines from both the NCSG and outside-gap that the measurement occasion of the first MO is the outside-gap when the measurement timing window of the first MO is partially overlapping with the NCSG; and/or
determine the first specific scaling factor for the first MO according to the period of the measurement timing window of the first MO and a measurement gap repetition period (MGRP), in response to that the terminal device determines from both the MG and the outside-gap that the measurement occasion of the first MO is the outside-gap when the measurement timing window of the first MO is partially overlapping with the MG; and/or
determine the first specific scaling factor for the first MO according to the period of the measurement timing window of the first MO, the MGRP, and the period of the NCSG, in response to that the terminal device determines from the NCSG, the MG, and the outside-gap that the measurement occasion of the first MO is the outside-gap when the measurement timing window of the first MO is partially overlapping with the MG and is partially overlapping with the NCSG.

17. The terminal device of claim 10, wherein the measurement occasion of the first MO is the NCSG and a carrier specific scaling factor (CSSF) for the first MO is a CSSF corresponding to the NCSG; or the measurement occasion of the first MO is the MG and the CSSF for the first MO is a CSSF corresponding to the MG.

18. The terminal device of claim 17, wherein the CSSF for the NCSG is determined according to at least one of:
number of primary carrier components (PCCs) to be measured within the NCSG;
number of secondary carrier components (SCCs) to be measured within the NCSG;
number of inter-frequency MOs to be measured within the NCSG;
number of intra-frequency MOs to be measured within the NCSG;
an NCSG sharing factor for the inter-frequency MOs and an NC SG sharing factor for the intra-frequency MOs; or
an operation scenario of the terminal device.

19. A chip comprising a processor configured to invoke and execute computer programs stored in a memory to enable a device equipped with the chip to:
determine a measurement occasion of a first measurement object (MO) in at least one measurement occasion according to whether a measurement gap (MG) and/or a network control small gap (NCSG) are needed for measurement of the first MO, wherein
the at least one measurement occasion comprises the NCSG.

20. The chip of claim 19, wherein the computer programs are further executed by the processor to enable the device equipped with the chip to perform at least one of:
determining, according to a first condition, whether the MG is needed for the measurement of the first MO;
determining, according to the first condition, whether the NCSG is needed for the measurement of the first MO;
determining, according to the first condition, whether the MG is needed for the measurement of the first MO, and determining, according to a second condition, whether the NCSG is needed for the measurement of the first MO in response to the MG being not needed for the measurement of the first MO; or
determining, according to the first condition, whether the MG is needed for the measurement of the first MO, and determining, according to a third condition, whether the NCSG is needed for the measurement of the first MO in response to the MG being needed for the measurement of the first MO.
